(19) United States
(12) Patent Application Publication
(10) Pub. No.: US 2024/0339670 A1
(43) Pub. Date: Oct. 10, 2024

(54) PHOSPHOROUS ELECTROLYTE ADDITIVES FOR AQUEOUS BATTERIES

(71) Applicant: OCTET SCIENTIFIC, INC., Cleveland, OH (US)

(72) Inventors: Onas James BOLTON, Pepper Pike, OH (US); Emily Janine Dickens, Cleveland, OH (US); Mark Rubino, Holland, MI (US); Akash Kota, Cleveland, OH (US)

(21) Appl. No.: 18/628,377

(22) Filed: Apr. 5, 2024

Related U.S. Application Data
(60) Provisional application No. 63/495,020, filed on Apr. 7, 2023.

(51) Int. Cl. H01M 10/26

(52) U.S. Cl. CPC H01M 10/26; H01M 2300/0014

(57) ABSTRACT

Provided herein are phosphorus battery electrolyte additive chemicals for use in aqueous batteries that prevent self-discharge in the form of corrosion and hydrogen evolution, which increases the efficiency and extends the shelf-life of the batteries.

### CROSS-REFERENCE TO RELATED APPLICATIONS

This application claims priority to, and the benefit of, U.S. Ser. No. 63/495,020 filed Apr. 7, 2023, the entirety of which is hereby incorporated by reference for all purposes.

### FIELD

The present disclosure concerns phosphorous electrolyte additives for use in zinc batteries. The additives prevent self-discharge, corrosion, and hydrogen evolution. By doing so, the additives set forth herein increase coulombic efficiency, increase cycle life, and extend the shelf-life of the zinc batteries.

### BACKGROUND

Zinc is non-toxic, inexpensive, and compatible with aqueous electrolytes. Zinc-based batteries are nonflammable and environmentally friendly. Zinc may evolve hydrogen gas when used in aqueous electrolyte batteries due to zinc electrode corrosion and self-discharge. This shortens battery shelf-life, reduces cycle efficiency and battery capacity, as well as increases internal pressure, which may cause mechanical failures. What is needed are compositions, including but not limited to aqueous electrolyte additives, and methods or making and using the same to, for example, reduce hydrogen evolution and corrosion in zinc-batteries.

### SUMMARY

Provided herein are novel zinc-battery phosphorous electrolyte additive chemicals. It has been surprisingly discovered that the phosphorous electrolyte additives described herein, optionally at particular concentrations and combinations, mitigate hydrogen evolution in zinc batteries and result in batteries with improved coulombic efficiency, shelf-life, and safety.

Provided herein are aqueous electrolytes comprising at least one electrolyte additive of Formula I or Formula II:

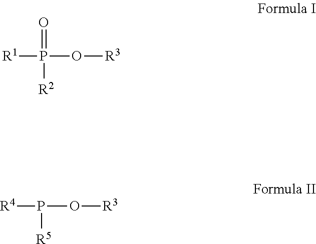

or a salt thereof, anion thereof, hydrolytic product thereof, tautomer thereof, or an electrochemical reduction product thereof;
wherein
R¹ and R² are independently selected from hydrogen, —OH, C₁₋₂₀alkoxy, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy wherein the C₆₋₁₀aryl, either alone or as part of another group, is optionally substituted with at least one R⁷;
R³ is hydrogen, C₁₋₆alkyl, hydroxyC₁₋₆alkyl, C₆₋₁₀aryl, or C₆₋₁₀arylC₁₋₆alkyl, wherein the C₆₋₁₀aryl or the C₆₋₁₀arylC₁₋₆alkyl is optionally substituted with at least one R⁷; or
R¹ and R³ together form a C₃₋₁₀heterocycle that contains at least the —P(R²)(O)O— group to which R¹ and R³ are attached; wherein the C₃₋₁₀heterocycle is optionally substituted with at least one R⁷ group; and/or the C₃₋₁₀heterocycle is optionally fused to one or two C₆₋₁₀aryl groups; or
R¹, R², and R³ together form a bridged C₃₋₁₀heterocycle that contains at least the —P(O)O— group to which R¹, R², and R³ are attached wherein the C₃₋₁₀heterocycle is optionally substituted with at least one R⁷ group;
R⁴ and R⁵ are independently selected from hydrogen, —OH, C₁₋₂₀alkoxy, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkyloxy wherein the C₆₋₁₀aryl, either alone or as part of another group, is optionally substituted with at least one R⁷; or
R³ and R⁴ together form a C₃₋₁₀heterocycle that contains at least the —P(R⁵)O— group to which R³ and R⁴ are attached; wherein the C₃₋₁₀heterocycle is optionally substituted with at least one R⁷ group; or
R³, R⁴, and R⁵ together form a bridged C₃₋₁₀heterocycle that contains at least the —P—O— group to which R³, R⁴, and R⁵ are attached wherein the C₃₋₁₀heterocycle is optionally substituted with at least one R⁷ group;
R⁶ is hydrogen or C₁₋₆alkyl; and
R⁷ is independently selected from C₁₋₆alkyl, —OH, and hydroxyC₁₋₆alkyl, and wherein R⁷ is not further substituted;
   wherein the aqueous electrolyte optionally further comprises one or more ions selected from the group consisting of Na⁺, K⁺, Ca²⁺, Zn²⁺, a quaternary ammonium cation with a net positive charge of one, and combinations thereof; and

wherein the at least one electrolyte additive is present in the aqueous electrolyte at a concentration equal to, or greater than, 0.001 weight percent (wt %) to less than, or equal to, 50 wt %.

In certain embodiments, the concentration of the electrolyte additive is the concentration of a single additive of Formula I, Formula II, Formula P-I, or Formula P-II, or a salt thereof, anion thereof, hydrolytic product thereof, or an electrochemical reduction product thereof. In certain embodiments, the concentration of the electrolyte additive is the concentration of a combination of additives of Formula I, Formula II, Formula P-I, and/or Formula P-II, or a salt thereof, anion thereof, hydrolytic product thereof, or electrochemical reduction product thereof.

In a preferred embodiment, the electrolyte additive or combination of electrolyte additives is present in the electrolyte at a concentration between about 0.001 wt % to 35 wt %. In one embodiment, the electrolyte additive or combination of electrolyte additives is present at a concentration between about 0.001 wt % and 10 wt %, between about 0.5 wt % and 5 wt %, between about 0.5 wt % and 1.5 wt %, between about 1 wt % and 2 wt %, or between about 0.001 wt % and 0.05 wt %. In a preferred embodiment, the electrolyte additive or combination of electrolyte additives is present in the electrolyte at a concentration of about 0.001 wt % to 35 wt %. In another preferred embodiment, the electrolyte additive or combination of electrolyte additives is present in the electrolyte at a concentration of about 0.001 wt % to 30 wt %. In one embodiment, the electrolyte additive or combination of electrolyte additives is present at a concentration of about 0.001 wt % and 10 wt %, of about 0.5 wt % and 5 wt %, of about 0.5 wt % and 1.5 wt %, of about 1 wt % and 2 wt %, or of about 0.001 wt % and 0.05 wt %. In one embodiment, the electrolyte additive or combination of electrolyte additives is present at a concentration of less than about 0.5 wt %. In one embodiment, the electrolyte additive or combination of electrolyte additives is present at a concentration of about 0.5 wt %. In one embodiment, the electrolyte additive or combination of electrolyte additives is present at a concentration of about 1 wt %. In one embodiment, the electrolyte additive or combination of electrolyte additives is present at a concentration of about 1.5 wt %. In one embodiment, the electrolyte additive or combination of electrolyte additives is present at a concentration of about 2 wt %.

In one embodiment, the aqueous electrolyte comprises two electrolyte additives and the concentration of each additive is between about 0.5 wt % and 5 wt %. In one embodiment, the aqueous electrolyte comprises two electrolyte additives and the combined concentration of the two additives is between about 0.5 wt % and 5 wt %.

In one embodiment, the aqueous electrolyte comprises two electrolyte additives and the concentration of each additive is between about 0.1 wt % and 1 wt %. In one embodiment, the aqueous electrolyte comprises two electrolyte additives and the combined concentration of the two additives is between about 0.1 wt % and 1 wt %.

In one embodiment, the aqueous electrolyte comprises two electrolyte additives and the concentration of each additive is between about 0.001 wt % and 0.5 wt %. In one embodiment, the aqueous electrolyte comprises two electrolyte additives and the combined concentration of the two additives is between about 0.001 wt % and 0.5 wt %.

In one embodiment, the electrolyte composition comprises an electrolyte additive of Formula IA, Formula IB, Formula IC, or Formula ID:

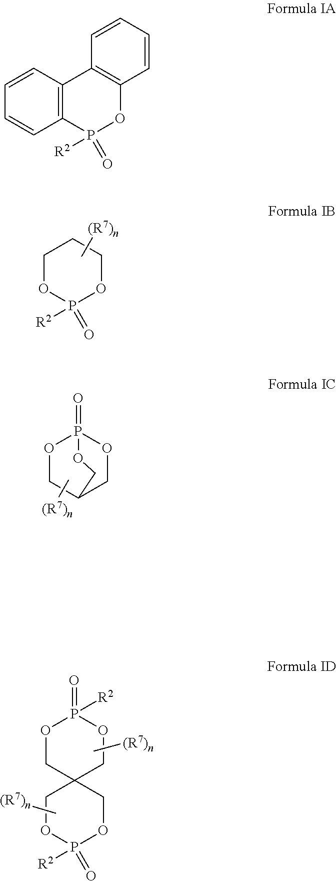

wherein R² and R⁷ are as defined herein and n is an integer selected from 0, 1, and 2.

In one embodiment, the electrolyte composition comprises an electrolyte additive of Formula IIA or Formula IIB:

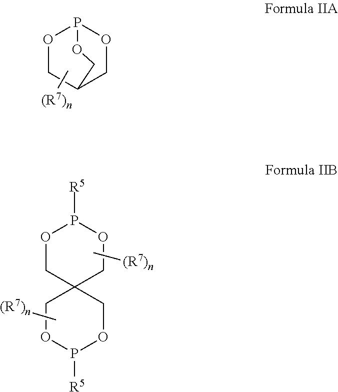

wherein R⁷, R⁵, and n are as defined herein.

The molecules disclosed herein exist in dynamic equilibrium with de-protonated analogs, in which the equilibrium constant is temperature dependent. For example, certain molecules have labile hydrogen ions (i.e., protons) and will exist in a thermodynamic equilibrium; the labile protons will associate and dissociate from the molecule. In basic electrolytes and certain acidic electrolytes, such as those often used with zinc batteries, the aforementioned battery additives may be present in the electrolyte in a deprotonated form. For example, under certain conditions, when R³ is H, R³ in Formula I and Formula II can exist as —O⁻ and not —OH to afford an additive of Formula I-1 and Formula II-1:

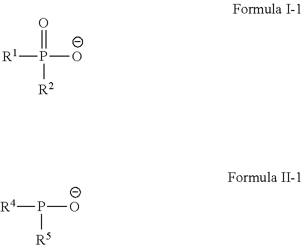

wherein Formula I-1 or Formula II-1 optionally further comprise a cation selected from Na⁺, K⁺, Zn²⁺, Ca²⁺, and a quaternary ammonium cation with a net positive charge. In one embodiment, a compound of Formula I-1 comprises K⁺. In one embodiment, a compound of Formula II-1 comprises K⁺.

Further, under certain conditions, when R² is OH in Formula I-1 and R⁵ is OH Formula II-1, R² and R⁵ can exist as —O⁻ and not —OH to afford an additive of Formula I-2 and Formula II-2:

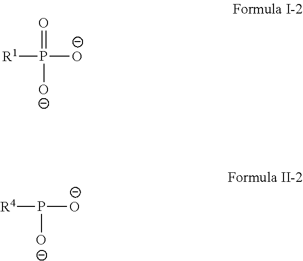

wherein Formula I-2 or Formula II-2 optionally further comprise one or more cations selected from Na⁺, K⁺, Zn²⁺, Ca²⁺, and a quaternary ammonium cation with a net positive charge. In one embodiment, a compound of Formula I-2 comprises two Na⁺ cations. In one embodiment, a compound of Formula II-2 comprises two Na⁺ cations.

Further, under certain conditions, if R¹ and R² are OH in Formula I-1, R′ and R² can both exist as —O⁻ and not —OH to afford an additive of Formula I-3. Similarly, if R⁴ and R⁵ are OH in Formula II-1, R⁴ and R⁵ can both exist as —O⁻ and not —OH to afford an additive of Formula II-3:

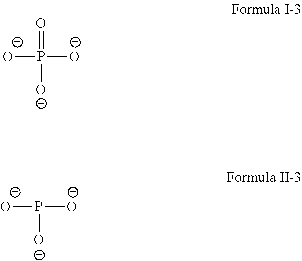

wherein Formula I-3 or Formula II-3 optionally further comprise one or more cations selected from Na⁺, K⁺, Zn²⁺, Ca²⁺, and a quaternary ammonium cation with a net positive charge.

Similarly when R² is OH in Formula IA, Formula IB, or ID, R² can exist as —O⁻ and not —OH to afford an additive of Formula IA-1, Formula IB-1, Formula ID-1, or ID-2:

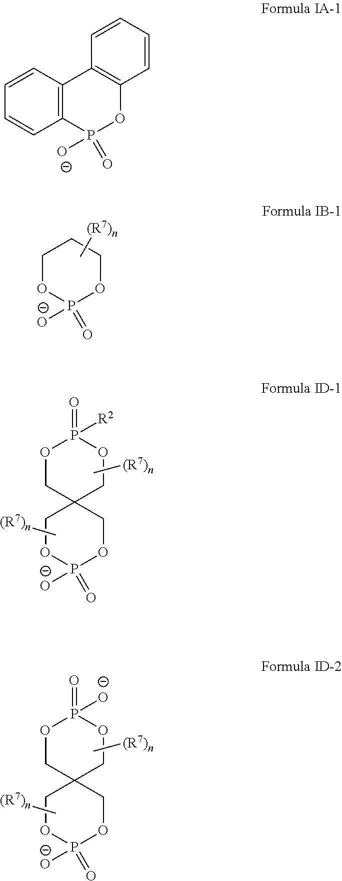

wherein Formula IA, Formula IB-1, Formula ID-1, or Formula ID-2 optionally further comprise one or more cations selected from Nat, K⁺, Zn²⁺, Ca²⁺, and a quaternary ammonium cation with a net positive charge.

When R⁵ is OH in Formula IIB, R⁵ can exist as —O⁻ and not —OH to afford an additive of Formula IIB-1 or Formula IIB-2:

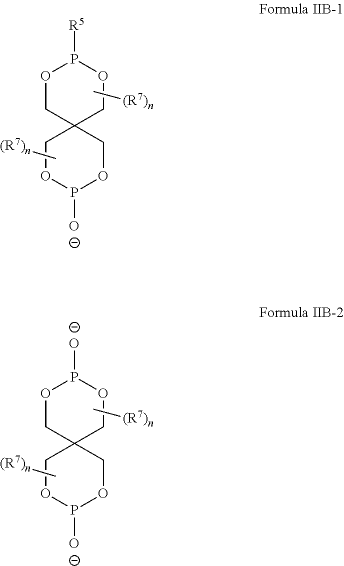

wherein Formula IIB-1 or Formula IIB-2 optionally further comprise one or more cations selected from Na⁺, K⁺, Zn²⁺, Ca²⁺, and a quaternary ammonium cation with a net positive charge.

In some embodiments of any of the electrolyte additives described herein, the cation is K⁺. In an alternative embodiment of any of the electrolyte additives described herein, the cation is any suitable cation that does not react with the electrolyte additive, including for example, H⁺ and Li⁺.

Optionally substituted substituents (e.g., R¹, R², R³, R⁴, R⁵, R⁶, or R⁷) are unsubstituted unless explicitly stated otherwise.

In the embodiments described herein, the bond represented by

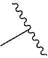

is the point of attachment to the rest of the compound.

In another example, set forth herein is a battery or electrochemical cell comprising at least one phosphorus electrolyte additive described herein. In certain embodiments, the battery comprises a zinc anode. Herein a phosphorus electrolyte additive includes a compound having at least one or more phosphorus atoms. The phosphorus atoms may be arranged and bonded in a variety of manners. In some embodiments, sets forth herein are compounds having phosphate functional groups. In some embodiments, sets forth herein are compounds having phosphonate functional groups. In some embodiments, sets forth herein are compounds having phosphinic functional groups. In some embodiments, sets forth herein are compounds having both phosphate and a phosphonate functional groups.

In another example, set forth herein is a process for making a zinc battery, comprising contacting an electrolyte having a phosphorus electrolyte additive described herein with a zinc-battery electrode.

In another example, set forth herein is a method of using a zinc battery, comprising electrochemically cycling a zinc-battery comprising an electrolyte having a phosphorus electrolyte additive set forth herein.

In another example, set forth herein is a method of reducing or eliminating self-discharge and/or preventing hydrogen production comprising (a) providing an electrochemical cell comprising a zinc-lithium, zinc-carbon, zinc-chloride, zinc-bromide, zinc-air, zinc-iron, zinc-manganese dioxide, zinc-iodide, zinc-nickel, or zinc-silver oxide anode-cathode; and (b) an aqueous electrolyte comprising KOH and at least one phosphorus electrolyte additive described herein.

### DETAILED DESCRIPTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the disclosure herein is not intended to be limited to the embodiments presented, but are to be accorded their widest scope consistent with the principles and novel features disclosed herein.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Please note, if used, the labels left, right, front, back, top, bottom, forward, reverse, clockwise and counterclockwise have been used for convenience purposes only and are not intended to imply any particular fixed direction. Instead, they are used to reflect relative locations and/or directions between various portions of an object.

### I. Definitions

As used herein, the singular forms “a,” “an” and “the” include plural referents unless the context clearly dictates otherwise.

As used herein, the term “about,” when qualifying a number, e.g., 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, zinc may be referred to by its IUPAC chemical symbol, Zn.

As used herein, “aqueous electrolyte” is an electrolyte wherein water is the solvent.

As used herein, “alkyl” refers to a monovalent and saturated hydrocarbon radical moiety. Alkyl is optionally substituted and can be linear, branched, or cyclic, i.e., cycloalkyl. Alkyl includes, but is not limited to, those having 1-10 carbon atoms, i.e., C₁₋₁₀ alkyl, or 1-6 carbon atoms, i.e., C₁₋₆ alkyl. In other embodiments, alkyl includes, but is not limited to, having 1-20 carbon atoms, i.e., C₁₋₂₀ alkyl. Examples of alkyl moieties include, but are not limited to methyl, ethyl, n-propyl, i-propyl, n-butyl, s-butyl, t-butyl, i-butyl, a pentyl moiety, a hexyl moiety, cyclopropyl, cyclobutyl, cyclopentyl, and cyclohexyl. In one embodiment, alkyl is linear. In one embodiment, alkyl is branched.

As used herein, “alkoxy” refers to the group-OR′ wherein R′ is alkyl. Alkoxy groups include, but are not limited to, methoxy, ethoxy, n-propoxy, isopropoxy, n-butoxy, tert-butoxy, and sec-butoxy. Alkoxy includes, but is not limited to, those having 1-20 carbon atoms, i.e., C₁₋₂₀alkoxy, 1-10 carbon atoms, i.e., C₁₋₁₀alkoxy. or 1-6 carbon atoms, i.e., C₁₋₆alkoxy.

As used herein, “aryloxy” refers to the group-OR″ wherein R″ is aryl.

As used herein, “aryl” refers to a monovalent moiety that is a radical of an aromatic compound wherein the ring atoms are carbon atoms. Aryl is optionally substituted and can be monocyclic or polycyclic, e.g., bicyclic or tricyclic. Examples of aryl moieties include, but are not limited to, those having 6 to 20 ring carbon atoms, i.e., C₆₋₂₀ aryl; 6 to 15 ring carbon atoms, i.e., C₆₋₁₅ aryl, and 6 to 10 ring carbon atoms, i.e., C₆₋₁₀ aryl. Examples of aryl moieties include, but are limited to, phenyl, naphthyl, fluorenyl, azulenyl, anthryl, phenanthryl, and pyrenyl.

As used herein, “arylalkoxy” refers to an alkoxy group, as used herein, substituted with an aryl group, as defined herein.

As used herein, “arylalkyl” refers to an alkyl group, as used herein, substituted with an aryl group, as defined herein. “Bn” or “benzyl” refers to “CH₂-phenyl.”

As used herein, “heterocycloalkyl” or “heterocycle” refers to a cycloalkyl in which one or more carbon atoms are replaced by heteroatoms. Suitable heteroatoms include, but are not limited to, nitrogen, oxygen, sulfur, and phosphorus. Heterocycloalkyl is optionally substituted. Examples of heterocycloalkyl moieties include, but are not limited to, 1,2-oxaphosphinane 2-oxide and 2,6,7-trioxa-1-phosphabicyclo[2.2.2]octane 1-oxide. Additional examples of heterocycloalkyl include morpholinyl, piperidinyl, tetrahydropyranyl, pyrrolidinyl, imidazolidinyl, oxazolidinyl, thiazolidinyl, dioxolanyl, dithiolanyl, oxanyl, or thianyl. In certain embodiments, the heterocycle is fused, for example to an aryl group or another heterocycle group. In certain embodiments, the heterocycle is a monovalent, monocyclic, or multicyclic fully-saturated ring system. In certain embodiments, the heterocycle group may be unsaturated, and/or bridged, and/or a fused bicyclic group, and/or a spirocyclic bicyclic group. The term “spiro bicyclic group” refers to a bicyclic heterocycloalkyl ring system in which 2 or 3 rings are linked together by one common atom. In some embodiments, a spiro bicyclic ring is a 3- to 10-membered spirocyclic bicyclic heterocycle comprising at least one, and preferably two, —O—P(O)(OR²)O-bonds. In some embodiments, a spiro bicyclic ring is a 3- to 10-membered spirocyclic bicyclic heterocycle comprising at least one, and preferably two, —O—P(OR⁵)O-bonds. The term “bridged bicyclic ring system” refers to a bicyclic heterocycloalkyl ring system in which the rings are bridged.

As used herein, “hydroxyalkyl” is an alkyl group, as used herein, substituted with at least one hydroxyl group.

As used herein, “halogen” and “halo” refer to chloro, bromo, iodo, or fluoro.

As used herein, “optionally substituted,” when used to describe a radical moiety, e.g., optionally substituted alkyl, means that such moiety is optionally bonded to one or more substituents. Examples of such substituents include, but are not limited to halo, cyano, nitro, haloalkyl, azido, epoxy, optionally substituted heteroaryl, optionally substituted heterocycloalkyl,

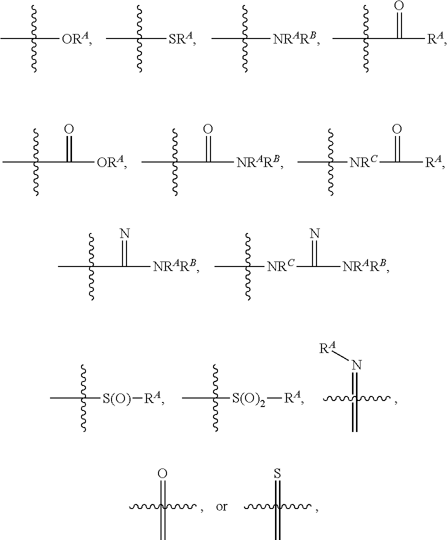

wherein R^{A}, R^{B}, and R^{C} are, independently at each occurrence, a hydrogen atom, alkyl, alkenyl, alkynyl, aryl, alkaryl, aralkyl, heteroalkyl, heteroaryl, or heterocycloalkyl, or R^{A} and R^{B}, together with the atoms to which they are bonded, form a saturated or unsaturated carbocyclic ring, wherein the ring is optionally substituted and wherein one or more ring atoms is optionally replaced with a heteroatom. In certain embodiments, when a radical moiety is optionally substituted with an optionally substituted heteroaryl, optionally substituted heterocycloalkyl, or optionally substituted saturated or unsaturated carbocyclic ring, the substituents on the optionally substituted heteroaryl, optionally substituted heterocycloalkyl, or optionally substituted saturated or unsaturated carbocyclic ring, if they are substituted, are not substituted with substituents which are further optionally substituted with additional substituents. In some embodiments, when a group described herein (e.g., R¹, R², R³, R⁴, and R⁵) is optionally substituted, the substituent bonded to the group is unsubstituted unless otherwise specified.

As used here, “a phosphorus electrolyte additive” is an aqueous electrolyte additive chemical that comprises at least one or more phosphate, phosphite, phosphonate, phosphine, phosphinic acid, or phosphonic acid function group.

### II. Electrolytes

Set forth herein are phosphorus electrolyte additives that are particularly useful in aqueous electrolytes in zinc batteries. Zinc batteries includes zinc-air batteries as well as other types of zinc batteries. In some examples the aqueous electrolytes contemplated herein are neutral (with respect to pH). In preferred examples, the aqueous electrolytes contemplated herein are basic (with respect to pH). One example of a basic electrolyte is a zinc-air battery. In addition, the electrolytes set forth herein may be used in zinc-manganese oxide batteries, nickel-zinc batteries, silver-zinc batteries, or zinc-lithium batteries. In certain embodiments, the pH of the aqueous electrolyte is basic with a pH of greater than about 7, for example greater than about 8, greater than about 9, greater than about 10, greater than about 11, greater than about 12, or greater than about 13. In certain embodiments, the pH of the aqueous electrolyte is about 8 to 13. In certain embodiments, the pH of the aqueous electrolyte is greater than 14. In certain embodiments, the pH of the aqueous electrolyte is about 10. In certain embodiments, including any of the foregoing, the aqueous electrolyte comprises potassium hydroxide (KOH). In certain embodiments, including any of the foregoing, the aqueous electrolyte comprises zinc (II) sulfate.

In one embodiment, the aqueous electrolyte comprises at least one electrolyte additive of Formula P-I or Formula P-II:

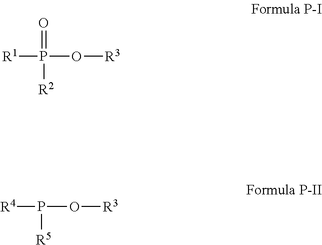

or a salt thereof, anion thereof, hydrolytic product thereof, or electrochemical reduction product thereof;
wherein
R¹ and R² are independently selected from hydrogen, —OH, C₁₋₆alkoxy, —CH₂C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy wherein the C₆₋₁₀aryl, either alone or as part of another group, is optionally substituted with at least one R⁷;
R³ is hydrogen, C₁₋₆alkyl, hydroxyC₁₋₆alkyl, C₆₋₁₀aryl, or C₆₋₁₀arylC₁₋₆alkyl, wherein the C₆₋₁₀aryl or the C₆₋₁₀arylC₁₋₆alkyl is optionally substituted with at least one R⁷; or
R¹ and R³ together form a C₃₋₁₀heterocycle that contains at least one oxygen atom; wherein the C₃₋₁₀heterocycle is optionally substituted with at least one R⁷ group; and/or the C₃₋₁₀heterocycle is optionally fused to one or two C₆₋₁₀aryl groups; or
R¹, R², and R³ together form a bridged C₃₋₁₀heterocycle that contains at least one oxygen atom and wherein the C₃₋₁₀heterocycle is optionally substituted with at least one R⁷ group;
R⁴ and R⁵ are independently selected from hydrogen, —OH, C₁₋₆alkoxy, —CH₂C(O)OR⁶, hydroxyC₁₋₆alkyl, C₆₋₁₀aryl, C₆₋₁₀arylC₁₋₆alkyl, C₆₋₁₀aryloxy, or C₆₋₁₀arylC₁₋₆alkyloxy wherein the C₆₋₁₀aryl, either alone or as part of another group, is optionally substituted with at least one R⁷;
R⁶ is hydrogen or C₁₋₆alkyl; and
R⁷ is independently selected from C₁₋₆alkyl and hydroxyC₁₋₆alkyl, and wherein R⁷ is not further substituted;
   wherein the aqueous electrolyte further comprises an ion selected from the group consisting of Na⁺, K⁺, Ca²⁺, Zn²⁺, a quaternary ammonium cation with a net positive charge of one, and combinations thereof; and

wherein the at least one electrolyte additive is present in the aqueous electrolyte at a concentration equal to, or greater than, 0.001 weight percent (wt %) to less than, or equal to, 50 wt %.

Formula I, Formula II, Formula P-I, and Formula P-II set forth herein are drawn as a neutrally charged molecules. However, molecules disclosed herein exist in dynamic equilibrium with de-protonated analogs, in which the equilibrium constant is temperature dependent. For example, certain molecules have labile hydrogen ions (i.e., protons) and will exist in a thermodynamic equilibrium; the labile protons will associate and dissociate from the molecule. In basic electrolytes, such as those often used with zinc batteries, the aforementioned battery additives may be present in the electrolyte in a deprotonated form. For example, the following electrolyte additives may be present in place of, or in addition to, the conjugate bases illustrated above.

In some embodiments, including any of the foregoing, set forth herein is an aqueous electrolyte comprising at least one electrolyte additive of Formula I, Formula II, Formula P-I, or Formula P-II or a salt thereof.

In some embodiments, including any of the foregoing, set forth herein is an aqueous electrolyte comprising at least one electrolyte additive of Formula I, Formula II, Formula P-I, or Formula P-II or anion thereof.

In some embodiments, including any of the foregoing, set forth herein is an aqueous electrolyte comprising at least one electrolyte additive of Formula I, Formula II, Formula P-I, or Formula P-II or hydrolytic product thereof.

In some embodiments, including any of the foregoing, set forth herein is an aqueous electrolyte comprising at least one electrolyte additive of Formula I, Formula II, Formula P-I, or Formula P-II or an electrochemical reduction product thereof.

For example, in certain embodiments, the additive of Formula I or Formula P-I is selected from a compound of Formula I-1:

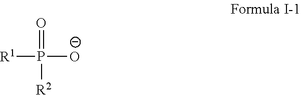

wherein Formula I-1 optionally further comprises a cation selected from Na⁺, K⁺, a quaternary ammonium cation with a net positive charge of one, Zn²⁺ and Ca²⁺. In one embodiment, the cation is K⁺.

In certain embodiments, the additive of Formula II or Formula P-II is selected from a compound of Formula II-1:

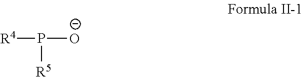

wherein Formula II-1 optionally further comprises a cation selected from Na⁺, K⁺, a quaternary ammonium cation with a net positive charge of one, Zn²⁺ and Ca²⁺. In one embodiment, the cation is K⁺.

Further, in certain embodiments, the additive of Formula I or Formula P-I is selected from a compound of Formula I-2 or the additive of Formula II or Formula P-II is selected from an additive of Formula II-2:

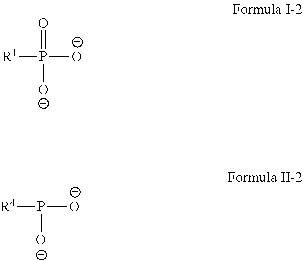

wherein Formula I-2 or Formula II-2 optionally further comprise one or more cations selected from Na⁺, K⁺, Zn²⁺, Ca²⁺, and a quaternary ammonium cation with a net positive charge. In one embodiment, the one or more cations is Na⁺.

In one embodiment, the aqueous electrolyte comprises one or more compounds selected from a compound of Formula I or Formula P-I or a salt thereof, anion thereof, hydrolytic product thereof, or electrochemical reduction product thereof; a compound of Formula I-1 or a salt thereof, hydrolytic product thereof, or electrochemical reduction product thereof; and, a compound of Formula I-2 or a salt thereof, hydrolytic product thereof, or electrochemical reduction product thereof.

In one embodiment, the aqueous electrolyte comprises one or more compounds selected from a compound of Formula II or Formula P-II or a salt thereof, anion thereof, hydrolytic product thereof, or electrochemical reduction product thereof; a compound of Formula II-1 or a salt thereof, hydrolytic product thereof, or electrochemical reduction product thereof; and, a compound of Formula II-2 or a salt thereof, hydrolytic product thereof, or electrochemical reduction product thereof.

In one embodiment, the aqueous electrolyte comprises a compound of Formula I or Formula P-I or a salt thereof, anion thereof, hydrolytic product thereof, or electrochemical reduction product thereof and a compound of Formula II or Formula P-II or a salt thereof, anion thereof, hydrolytic product thereof, or electrochemical reduction product thereof.

In one embodiment, the aqueous electrolyte comprises two or more compounds selected from (a) a compound of Formula I of Formula P-I or a salt thereof, anion thereof, hydrolytic product thereof, or an electrochemical reduction product thereof; (b) a compound of Formula II or Formula P-II or a salt thereof, anion thereof, hydrolytic product thereof, or an electrochemical reduction product thereof; (c) a compound of Formula I-1 or a salt thereof, hydrolytic product thereof, or an electrochemical reduction product thereof; (d) a compound of Formula II-1 or a salt thereof, hydrolytic product thereof, or an electrochemical reduction product thereof; (c) a compound of Formula I-2 or a salt thereof, hydrolytic product thereof, or an electrochemical reduction product thereof; and, (f) a compound of Formula II-2 or a salt thereof, hydrolytic product thereof, or an electrochemical reduction product thereof.

In one embodiment of Formula I, Formula II, Formula P-I, or Formula P-II, including any of the foregoing, R³ is hydrogen or C₁₋₆alkyl. In one embodiment of Formula I, Formula II, Formula P-I, or Formula P-II, including any of the foregoing, R³ is hydrogen. In one embodiment of Formula I, Formula II, Formula P-I, or Formula P-II, including any of the foregoing, R³ is C₁₋₆alkyl. In one embodiment of Formula I, Formula II, Formula P-I, or Formula P-II, including any of the foregoing, R³ is methyl or ethyl. In one embodiment of Formula I, Formula II, Formula P-I, or Formula P-II, including any of the foregoing, R³ is C₆₋₁₀aryl or C₆₋₁₀arylC₁₋₆alkyl, wherein the C₆₋₁₀aryl or the C₆₋₁₀arylC₁₋₆alkyl is optionally substituted with at least one R⁷. In one embodiment of Formula I, Formula II, Formula P-I, or Formula P-II, including any of the foregoing, R³ is unsubstituted C₆₋₁₀aryl or C₆₋₁₀arylC₁₋₆alkyl. In one embodiment of Formula I or Formula II, including any of the foregoing, R³ is hydroxyC₁₋₆alkyl.

In one embodiment of Formula I, Formula P-I, Formula I-1, or Formula I-2, including any of the foregoing, R¹ is hydrogen. In one embodiment of Formula I, Formula P-I, Formula I-1, or Formula I-2, including any of the foregoing, R¹ is C₁₋₆alkoxy. In one embodiment of Formula I, Formula I-1, or Formula I-2, including any of the foregoing, R¹ is C₁₋₂₀alkoxy. In one embodiment of Formula I, Formula I-1, or Formula I-2, including any of the foregoing, R¹ is C₁₀₋₂₀alkoxy. In one embodiment of Formula I, Formula I-1, or Formula 1-2, including any of the foregoing, R¹ is C₁₅₋₂₀alkoxy. In one embodiment of Formula I, Formula I-1, or Formula I-2, including any of the foregoing, R¹ is C₁₇alkoxy. In one embodiment of Formula I, Formula I-1, or Formula I-2, including any of the foregoing, R¹ is —C₁₋₆alkyl-C(O)OR⁶. In one embodiment of Formula I, Formula P-I, Formula I-1, or Formula I-2, including any of the foregoing, R¹ is —CH₂C(O)OR⁶. In one embodiment of Formula I, Formula P-I, Formula I-1, or Formula I-2, including any of the foregoing, R¹ is —CH₂CH₂C(O)OR⁶. In one embodiment of Formula I, Formula P-I, Formula I-1, or Formula I-2, including any of the foregoing, R¹ is —CH₂C(O)OH. In one embodiment of Formula I, Formula I-1, or Formula I-2, including any of the foregoing, R¹ is —CH₂CH₂C(O)OH. In one embodiment of Formula I, Formula P-I, Formula I-1, or Formula I-2, including any of the foregoing, R¹ is —CH₂C(O)OC₁₋₆alkyl. In one embodiment of Formula I, Formula P-I, Formula I-1, or Formula I-2, including any of the foregoing, R¹ is —CH₂C(O)OCH₃. In one embodiment of Formula I, Formula I-1, or Formula I-2, including any of the foregoing, R¹ is —CH₂CH₂C(O) CH₃. In one embodiment of Formula I, Formula P-I, Formula I-1, or Formula I-2, including any of the foregoing, R¹ is hydroxyC₁₋₆alkyl.

In one embodiment of Formula I, Formula P-I, Formula I-1, or Formula I-2, including any of the foregoing, R¹ is unsubstituted C₆₋₁₀aryl. In one embodiment of Formula I, Formula P-I, Formula I-1, or Formula I-2, including any of the foregoing, R¹ is C₆₋₁₀aryl optionally substituted with one R⁷. In one embodiment of Formula I, Formula P-I, Formula I-1, or Formula I-2, including any of the foregoing, R¹ is C₆₋₁₀aryl optionally substituted with one C₁₋₆alkyl. In one embodiment of Formula I, Formula P-I, Formula I-1, or Formula I-2, including any of the foregoing, R¹ is C₆₋₁₀aryl optionally substituted with one methyl group. In one embodiment of Formula I, Formula P-I, Formula I-1, or Formula I-2, including any of the foregoing, R¹ is unsubstituted phenyl. In one embodiment of Formula I, Formula P-I, Formula I-1, or Formula I-2, including any of the foregoing, R¹ is phenyl substituted with one methyl group. In one embodiment of Formula I, Formula P-I, Formula I-1, or Formula I-2, including any of the foregoing, R¹ is phenyl substituted with one methyl group in the para position.

In one embodiment of Formula I, Formula P-I, Formula I-1, or Formula I-2, including any of the foregoing, R¹ is C₆₋₁₀arylC₁₋₆alkyl wherein the aryl group is optionally substituted with at least one R⁷. In one embodiment of Formula I, Formula P-I, Formula I-1, or Formula I-2, including any of the foregoing, R¹ is C₆₋₁₀aryloxy wherein the aryl group is optionally substituted with at least one R⁷. In one embodiment of Formula I, Formula P-I, Formula I-1, or Formula I-2, including any of the foregoing, R¹ is C₆₋₁₀arylC₁₋₆alkoxy wherein the aryl group is optionally substituted with at least one R⁷.

In one embodiment of Formula I, Formula P-I, or Formula I-1, including any of the foregoing, R² is hydrogen. In one embodiment of Formula I, Formula P-I, or Formula I-1, including any of the foregoing, R² is C₁₋₆alkoxy. In one embodiment of Formula I, Formula I-1, or Formula I-2, including any of the foregoing, R² is C₁₋₂₀alkoxy. In one embodiment of Formula I, Formula I-1, or Formula I-2, including any of the foregoing, R² is C₁₀₋₂₀alkoxy. In one embodiment of Formula I, Formula I-1, or Formula I-2, including any of the foregoing, R² is C₁₅₋₂₀alkoxy. In one embodiment of Formula I, Formula I-1, or Formula I-2, including any of the foregoing, R² is C₁₇alkoxy. In one embodiment of Formula I, Formula I-1, or Formula I-2, including any of the foregoing, R² is —C₁₋₆alkyl-C(O)OR⁶. In one embodiment of Formula I, Formula P-I, or Formula I-1, including any of the foregoing, R² is —CH₂C(O)OR⁶. In one embodiment of Formula I, Formula P-I, Formula I-1, or Formula I-2, including any of the foregoing, R² is —CH₂CH₂C(O)OR⁶. In one embodiment of Formula I, Formula P-I, or Formula I-1, including any of the foregoing, R² is —CH₂C(O)OH. In one embodiment of Formula I, Formula I-1, or Formula I-2, including any of the foregoing, R² is —CH₂CH₂C(O)OH. In one embodiment of Formula I, Formula P-I, or Formula I-1, including any of the foregoing, R² is —CH₂C(O)OC₁₋₆alkyl. In one embodiment of Formula I, Formula P-I, or Formula I-1, including any of the foregoing, R² is —CH₂C(O)OCH₃. In one embodiment of Formula I, Formula I-1, or Formula I-2, including any of the foregoing, R² is —CH₂CH₂C(O) CH₃. In one embodiment of Formula I, Formula P-I, or Formula I-1, including any of the foregoing, R² is hydroxyC₁₋₆alkyl.

In one embodiment of Formula I, Formula P-I, or Formula I-1, including any of the foregoing, R² is unsubstituted C₆₋₁₀aryl. In one embodiment of Formula I, Formula P-I, or Formula I-1, including any of the foregoing, R² is C₆₋₁₀aryl optionally substituted with one R⁷. In one embodiment of Formula I, Formula P-I, or Formula I-1, including any of the foregoing, R² is C₆₋₁₀aryl optionally substituted with one C₁₋₆alkyl. In one embodiment of Formula I, Formula P-I, or Formula I-1, including any of the foregoing, R² is C₆₋₁₀aryl optionally substituted with one methyl group. In one embodiment of Formula I, Formula P-I, or Formula I-1, including any of the foregoing, R² is unsubstituted phenyl. In one embodiment of Formula I, Formula P-I, or Formula I-1, including any of the foregoing, R² is phenyl substituted with one methyl group. In one embodiment of Formula I, Formula P-I, or Formula I-1, including any of the foregoing, R² is phenyl substituted with one methyl group in the para position.

In one embodiment of Formula I, Formula P-I, or Formula I-1, including any of the foregoing, R² is C₆₋₁₀arylC₁₋₆alkyl wherein the aryl group is optionally substituted with at least one R⁷. In one embodiment of Formula I, Formula P-I, or Formula I-1, including any of the foregoing, R² is C₆₋₁₀aryloxy wherein the aryl group is optionally substituted with at least one R⁷. In one embodiment of Formula I, Formula P-I, or Formula I-1, including any of the foregoing, R² is C₆₋₁₀arylC₁₋₆alkoxy wherein the aryl group is optionally substituted with at least one R⁷.

In one embodiment of Formula I, or Formula I-1, including any of the foregoing, R¹ and R² are independently selected from hydrogen, —OH, C₁₋₆alkoxy, C₆₋₁₀aryl, and —C₁₋₆alkyl-C(O)OR⁶ wherein the C₆₋₁₀aryl group is optionally substituted with C₁₋₆alkyl. In one embodiment of Formula I, Formula P-I, or Formula I-1, including any of the foregoing, R¹ and R² are independently selected from hydrogen, —OH, C₁₋₆alkoxy, C₆₋₁₀aryl, and —CH₂C(O)OR⁶ wherein the C₆₋₁₀aryl group is optionally substituted with C₁₋₆alkyl. In one embodiment of Formula I, or Formula I-1, including any of the foregoing, R¹ and R² are independently selected from hydrogen, —OH, C₁₋₆alkoxy, C₆₋₁₀aryl, and —C₁₋₆alkyl-C(O)OR⁶ wherein the C₆₋₁₀aryl group is optionally substituted with C₁₋₆alkyl. In one embodiment of Formula I, Formula P-I, or Formula I-1, R¹ and R² are independently selected from hydrogen, C₁₋₆alkoxy, C₆₋₁₀aryl, and —CH₂C(O)OR⁶ wherein the C₆₋₁₀aryl group is optionally substituted with C₁₋₆alkyl. In one embodiment of Formula I, or Formula I-1, R¹ and R² are independently selected from hydrogen, C₁₋₆alkoxy, C₆₋₁₀aryl, and —C₁₋₆alkyl-C(O)OR⁶ wherein the C₆₋₁₀aryl group is optionally substituted with C₁₋₆alkyl. In one embodiment of Formula I, Formula P-I, or Formula I-1, including any of the foregoing, R¹ and R² are independently selected from hydrogen, —OH, C₁₋₆alkoxy, and C₆₋₁₀aryl wherein the C₆₋₁₀aryl group is unsubstituted. In one embodiment of Formula I, Formula P-I, or Formula I-1, including any of the foregoing, R¹ and R² are independently selected from hydrogen, —OH, and C₆₋₁₀aryl wherein the C₆₋₁₀aryl group is unsubstituted.

In one embodiment of Formula I, Formula P-I, or Formula I-1, including any of the foregoing, R¹ and R² are both C₁₋₆alkoxy or are both C₆₋₁₀aryl. In one embodiment of Formula I, Formula P-I, or Formula I-1, including any of the foregoing, R¹ and R² are both C₁₋₆alkoxy. In one embodiment of Formula I, Formula P-I, or Formula I-1, including any of the foregoing, R¹ and R² are both C₁₋₂₀alkoxy. In one embodiment of Formula I, Formula P-I, or Formula I-1, including any of the foregoing, R¹ and R² are both C₁₀₋₂₀alkoxy. In one embodiment of Formula I, Formula P-I, or Formula I-1, including any of the foregoing, R¹ and R² are both C₁₅₋₂₀alkoxy. In one embodiment of Formula I, Formula P-I, or Formula I-1, including any of the foregoing, R¹ and R² are both C₁₇alkoxy. In one embodiment of Formula I, Formula P-I, or Formula I-1, including any of the foregoing, R¹ and R² are both methoxy. In one embodiment of Formula I, Formula P-I, or Formula I-1, including any of the foregoing, R¹ and R² are both ethoxy. In one embodiment of Formula I, Formula P-I, or Formula I-1, including any of the foregoing, R¹ and R² are both unsubstituted C₆₋₁₀aryl. In one embodiment of Formula I, Formula P-I, or Formula I-1, including any of the foregoing, R¹ and R² are both C₆₋₁₀aryl optionally substituted with one R⁷ group.

In one embodiment of Formula I, Formula P-I, or Formula I-1, including any of the foregoing, R¹ is hydrogen and R² is C₆₋₁₀aryl optionally substituted with one R⁷ group. In one embodiment of Formula I, Formula P-I, or Formula I-1, including any of the foregoing, R¹ is hydrogen and R² is unsubstituted C₆₋₁₀aryl. In one embodiment of Formula I, Formula P-I, or Formula I-1, including any of the foregoing, R¹ is hydrogen and R² is unsubstituted phenyl. In one embodiment of Formula I, Formula P-I, or Formula I-1, including any of the foregoing, R¹ is hydrogen and R² is C₆₋₁₀aryl optionally substituted with one C₁₋₆alkyl group. In one embodiment of Formula I, Formula P-I, or Formula I-1, including any of the foregoing, R¹ is hydrogen and R² is C₆₋₁₀aryl optionally substituted with one methyl group. In one embodiment of Formula I, Formula P-I, or Formula I-1, including any of the foregoing, R¹ is hydrogen and R² is phenyl optionally substituted with one methyl group in the para position.

In one embodiment of Formula I, Formula P-I, or Formula I-1, including any of the foregoing, R¹ is hydroxy and R² is C₆₋₁₀aryl optionally substituted with one R⁷ group. In one embodiment of Formula I, Formula P-I, or Formula I-1, including any of the foregoing, R¹ is hydroxy and R² is unsubstituted C₆₋₁₀aryl. In one embodiment of Formula I, Formula P-I, or Formula I-1, including any of the foregoing, R¹ is hydroxy and R² is unsubstituted phenyl. In one embodiment of Formula I, Formula P-I, or Formula I-1, including any of the foregoing, R¹ is hydroxy and R² is C₆₋₁₀aryl optionally substituted with one C₁₋₆alkyl group. In one embodiment of Formula I, Formula P-I, or Formula I-1, including any of the foregoing, R¹ is hydroxy and R² is C₆₋₁₀aryl optionally substituted with one methyl group. In one embodiment of Formula I, Formula P-I, or Formula I-1, including any of the foregoing, R¹ is hydroxy and R² is phenyl optionally substituted with one methyl group in the para position.

In one embodiment of Formula I, Formula P-I, or Formula I-1, including any of the foregoing, R¹ is C₁₋₆alkoxy and R² is —CH₂C(O)OR⁶. In one embodiment of Formula I, Formula P-I, or Formula I-1, including any of the foregoing, R¹ is C₁₋₆alkoxy and R² is —CH₂C(O)OH. In one embodiment of Formula I, Formula P-I, or Formula I-1, including any of the foregoing, R¹ is C₁₋₆alkoxy and R² is —CH₂C(O)OC₁₋₆alkyl. In one embodiment of Formula I, Formula P-I, or Formula I-1, including any of the foregoing, R¹ is C₁₋₆alkoxy and R² is —CH₂C(O)OCH₃. In one embodiment of Formula I, Formula P-I, or Formula I-1, including any of the foregoing, R¹ is methoxy and R² is —CH₂C(O)OR⁶. In one embodiment of Formula I, Formula P-I, or Formula I-1, including any of the foregoing, R¹ is methoxy and R² is —CH₂C(O)OH. In one embodiment of Formula I, Formula P-I, or Formula I-1, including any of the foregoing, R¹ is methoxy and R² is —CH₂C(O)OC₁₋₆alkyl. In one embodiment of Formula I, Formula P-I, or Formula I-1, including any of the foregoing, R¹ is methoxy and R² is —CH₂C(O)OCH₃. In one embodiment of Formula I, Formula P-I, or Formula I-1, including any of the foregoing, R¹ is ethoxy and R² is —CH₂C(O)OR⁶. In one embodiment of Formula I, Formula P-I, or Formula I-1, including any of the foregoing, R¹ is ethoxy and R² is —CH₂C(O)OH. In one embodiment of Formula I, Formula P-I, or Formula I-1, including any of the foregoing, R¹ is ethoxy and R² is —CH₂C(O)OC₁₋₆alkyl. In one embodiment of Formula I, Formula P-I, or Formula I-1, including any of the foregoing, R¹ is ethoxy and R² is —CH₂C(O)OCH₃. In one embodiment of Formula I, or Formula I-1, including any of the foregoing, R¹ is C₆₋₁₀aryl and R² is —C₁₋₆alkyl-C(O)OR⁶. In one embodiment of Formula I, or Formula I-1, including any of the foregoing, R¹ is C₆₋₁₀aryl and R² is —CH₂CH₂—C(O)OR⁶.

In one embodiment of Formula I or Formula P-I, R¹ and R³ together form a C₃₋₁₀heterocycle that contains at least the —P(R²)(O)O— group to which R¹ and R³ are attached. In one embodiment of Formula I or Formula P-I, R¹ and R³ together form a C₃₋₁₀heterocycle that contains at least the —P(R²)(O)O— group to which R¹ and R³ are attached and wherein the C₃₋₁₀heterocycle is optionally substituted with at least one R⁷ group and/or the C₃₋₁₀heterocycle is fused to one or two aryl groups.

In one embodiment of Formula I or Formula P-I, R¹ and R³ together form a C₃₋₁₀heterocycle that contains at least the —P(R²)(O)O— group to which R¹ and R³ are attached and the C₃₋₁₀heterocycle is fused to one or two aryl groups. For example, in one embodiment, the compound of Formula I or Formula P-I is a compound of Formula IA:

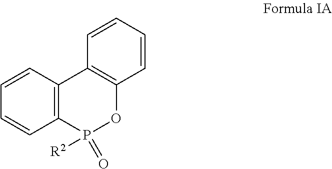

or a salt thereof, an anion thereof, a hydrolytic product thereof, or a reduction product thereof.

In one embodiment of Formula IA, R² is hydrogen, hydroxy, or C₁₋₆alkoxy. In one embodiment of Formula IA, R² is hydrogen. In one embodiment of Formula IA, R² is C₆₋₁₀aryl optionally substituted with at least one R⁷. In one embodiment of Formula IA, R² is C₆₋₁₀aryl optionally substituted with at least one hydroxy. In one embodiment of Formula IA, R² is C₆₋₁₀aryl optionally substituted with two hydroxy groups. In one embodiment of Formula IA, R² is phenyl optionally substituted with two hydroxy groups.

In one embodiment of Formula I or Formula P-I, R¹ and R³ together form a C₃₋₁₀heterocycle that contains at least the —P(R²)(O)O— group to which R¹ and R³ are attached and wherein the C₃₋₁₀heterocycle is optionally substituted with at least one R⁷ group. For example, in one embodiment, the compound of Formula I or Formula P-I is a compound of Formula 1B:

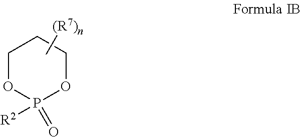

or a salt thereof, an anion thereof, a hydrolytic product thereof, or a reduction product thereof; wherein n is an integer selected from 0, 1, and 2.

In one embodiment of Formula IB, R² is hydrogen, hydroxy, or alkoxy. In one embodiment of Formula IB, R² is hydrogen.

In one embodiment of Formula IB, including any of the foregoing, n is 0. In one embodiment of Formula IB, including any of the foregoing, n is 1. In one embodiment of Formula IB, including any of the foregoing, n is 2.

In one embodiment of Formula IB, including any of the foregoing, R⁷ is independently selected from C₁₋₆alkyl and hydroxyC₁₋₆alkyl. In one embodiment of Formula IB, including any of the foregoing, n is 1 and R⁷ is C₁₋₆alkyl. In one embodiment of Formula IB, including any of the foregoing, n is 2 and R⁷ is C₁₋₆alkyl. In one embodiment of Formula IB, including any of the foregoing, n is 2 and R⁷ is methyl.

In one embodiment of Formula I or Formula P-I, R¹, R², and R³ together form a bridged C₃₋₁₀heterocycle that contains at least the —P(O)O— group to which R¹, R², and R³ are attached optionally substituted with at least one R⁷ group. For example, in one embodiment, the compound of Formula I or Formula P-I is a compound of Formula 1C:

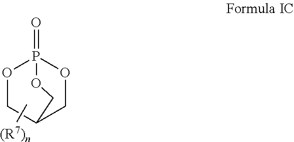

or a salt thereof, an anion thereof, a hydrolytic product thereof, or a reduction product thereof; wherein n is an integer selected from 0, 1, and 2.

In one embodiment of Formula IC, including any of the foregoing, n is 0. In one embodiment of Formula IC, including any of the foregoing, n is 1. In one embodiment of Formula IC, including any of the foregoing, n is 2.

In one embodiment of Formula IC, including any of the foregoing, R⁷ is independently selected from alkyl and hydroxyC₁₋₆alkyl. In one embodiment of Formula IC, including any of the foregoing, n is 1 and R⁷ is hydroxyC₁₋₆alkyl. In one embodiment of Formula IC, including any of the foregoing, n is 1 and R⁷ is —CH₂OH.

In one embodiment of Formula I or Formula P-I, R¹, R², and R³ together form a spirocyclic C₃₋₁₀heterocycle that contains at least the —P(R²)(O)O— group to which R¹ and R³ are attached and wherein the spirocyclic C₃₋₁₀heterocycle is optionally substituted with at least one R⁷ group. For example, in one embodiment, the compound of Formula I or Formula P-I is a compound of Formula 1D:

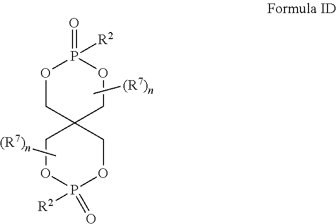

or a salt thereof, an anion thereof, a hydrolytic product thereof, or a reduction product thereof; wherein R², R⁷, and n are as defined herein.

In one embodiment of Formula ID, including any of the foregoing, n is 0.

In one embodiment of Formula ID, including any of the foregoing, R² is C₆₋₁₀aryloxy optionally substituted with at least one R⁷. In one embodiment of Formula ID, including any of the foregoing, R² is C₆₋₁₀aryloxy optionally substituted with at least one C₁₋₆alkyl group. In one embodiment of Formula ID, including any of the foregoing, R² is C₆₋₁₀aryloxy optionally substituted with two C₁₋₆alkyl groups. In one embodiment of Formula ID, including any of the foregoing, R² is —O-phenyl optionally substituted with two C₁₋₆alkyl groups. In one embodiment of Formula ID, including any of the foregoing, R² is —O-phenyl optionally substituted with two tert-butyl groups.

In one embodiment of Formula II, Formula P-II, Formula II-1, or Formula II-2, including any of the foregoing, R⁴ is hydrogen. In one embodiment of Formula II, Formula P-II, Formula II-1, or Formula II-2, including any of the foregoing, R⁴ is C₁₋₆alkoxy. In one embodiment of Formula II, Formula P-II, Formula II-1, or Formula II-2, including any of the foregoing, R⁴ is —CH₂C(O)OR⁶. In one embodiment of Formula II, Formula P-II, Formula II-1, or Formula II-2, including any of the foregoing, R⁴ is —CH₂C(O)OH. In one embodiment of Formula II, Formula P-II, Formula II-1, or Formula II-2, including any of the foregoing, R⁴ is —CH₂C(O)OC₁₋₆alkyl. In one embodiment of Formula II, Formula P-II, Formula II-1, or Formula II-2, including any of the foregoing, R⁴ is —CH₂C(O)OCH₃. In one embodiment of Formula II, Formula P-II, Formula II-1, or Formula II-2, including any of the foregoing, R⁴ is hydroxyC₁₋₆alkyl.

In one embodiment of Formula II, Formula P-II, Formula II-1, or Formula II-2, including any of the foregoing, R⁴ is unsubstituted C₆₋₁₀aryl. In one embodiment of Formula II, Formula P-II, Formula II-1, or Formula II-2, including any of the foregoing, R⁴ is C₆₋₁₀aryl optionally substituted with one R⁷. In one embodiment of Formula II, Formula P-II, Formula II-1, or Formula II-2, including any of the foregoing, R⁴ is C₆₋₁₀aryl optionally substituted with one C₁₋₆alkyl. In one embodiment of Formula II, Formula P-II, Formula II-1, or Formula II-2, including any of the foregoing, R⁴ is C₆₋₁₀aryl optionally substituted with one methyl group. In one embodiment of Formula II, Formula P-II, Formula II-1, or Formula II-2, including any of the foregoing, R⁴ is unsubstituted phenyl. In one embodiment of Formula II, Formula P-II, Formula II-1, or Formula II-2, including any of the foregoing, R⁴ is phenyl substituted with one methyl group. In one embodiment of Formula II, Formula P-II, Formula II-1, or Formula II-2, including any of the foregoing, R⁴ is phenyl substituted with one methyl group in the para position.

In one embodiment of Formula II, Formula P-II, Formula II-1, or Formula II-2, including any of the foregoing, R⁴ is C₆₋₁₀arylC₁₋₆alkyl wherein the aryl group is optionally substituted with at least one R⁷. In one embodiment of Formula II, Formula P-II, Formula II-1, or Formula II-2, including any of the foregoing, R⁴ is C₆₋₁₀aryloxy wherein the aryl group is optionally substituted with at least one R⁷. In one embodiment of Formula II, Formula P-II, Formula II-1, or Formula II-2, including any of the foregoing, R⁴ is C₆₋₁₀arylC₁₋₆alkoxy wherein the aryl group is optionally substituted with at least one R⁷.

In one embodiment of Formula II, Formula P-II, or Formula II-1, including any of the foregoing, R⁵ is hydrogen. In one embodiment of Formula II, Formula P-II, or Formula II-1, including any of the foregoing, R⁵ is C₁₋₆alkoxy. In one embodiment of Formula II, Formula P-II, or Formula II-1, including any of the foregoing, R⁵ is —CH₂C(O)OR⁶. In one embodiment of Formula II, Formula P-II, or Formula II-1, including any of the foregoing, R⁵ is —CH₂C(O)OH. In one embodiment of Formula II, Formula P-II, or Formula II-1, including any of the foregoing, R⁵ is —CH₂C(O)OC₁₋₆alkyl. In one embodiment of Formula II, Formula P-II, or Formula II-1, including any of the foregoing, R⁵ is —CH₂C(O)OCH₃. In one embodiment of Formula II, Formula P-II, or Formula II-1, including any of the foregoing, R⁵ is hydroxyC₁₋₆alkyl.

In one embodiment of Formula II, Formula P-II, or Formula II-1, including any of the foregoing, R⁵ is unsubstituted C₆₋₁₀aryl. In one embodiment of Formula II, Formula P-II, or Formula II-1, including any of the foregoing, R⁵ is C₆₋₁₀aryl optionally substituted with one R⁷. In one embodiment of Formula II, Formula P-II, or Formula II-1, including any of the foregoing, R⁵ is C₆₋₁₀aryl optionally substituted with one C₁₋₆alkyl. In one embodiment of Formula II, Formula P-II, or Formula II-1, including any of the foregoing, R⁵ is C₆₋₁₀aryl optionally substituted with one methyl group. In one embodiment of Formula II, Formula P-II, or Formula II-1, including any of the foregoing, R⁵ is unsubstituted phenyl. In one embodiment of Formula II, Formula P-II, or Formula II-1, including any of the foregoing, R⁵ is phenyl substituted with one methyl group. In one embodiment of Formula II, Formula P-II, or Formula II-1, including any of the foregoing, R⁵ is phenyl substituted with one methyl group in the para position.

In one embodiment of Formula II, Formula P-II, or Formula II-1, including any of the foregoing, R⁵ is C₆₋₁₀arylC₁₋₆alkyl wherein the aryl group is optionally substituted with at least one R⁷. In one embodiment of Formula II, Formula P-II, or Formula II-1, including any of the foregoing, R⁵ is C₆₋₁₀aryloxy wherein the aryl group is optionally substituted with at least one R⁷. In one embodiment of Formula II, Formula P-II, or Formula II-1, including any of the foregoing, R⁵ is C₆₋₁₀arylC₁₋₆alkoxy wherein the aryl group is optionally substituted with at least one R⁷.

In one embodiment of Formula II, Formula P-II, or Formula II-1, including any of the foregoing, R⁴ and R⁵ are both C₁₋₆alkoxy. In one embodiment of Formula II, Formula P-II, or Formula II-1, including any of the foregoing, R⁴ and R⁵ are both methoxy. In one embodiment of Formula II, Formula P-II, or Formula II-1, including any of the foregoing, R⁴ and R⁵ are both ethoxy. In one embodiment of Formula II, Formula P-II, or Formula II-1, including any of the foregoing, R⁴ and R⁵ are both unsubstituted C₆₋₁₀aryl. In one embodiment of Formula II, Formula P-II, or Formula II-1, including any of the foregoing, R⁴ and R⁵ are both C₆₋₁₀aryl optionally substituted with one R⁷ group.

In one embodiment of Formula II, Formula P-II, or Formula II-1, including any of the foregoing, R⁴ is hydrogen and R⁵ is C₆₋₁₀aryl optionally substituted with one R⁷ group. In one embodiment of Formula II, Formula P-II, or Formula II-1, including any of the foregoing, R⁴ is hydrogen and R⁵ is unsubstituted C₆₋₁₀aryl. In one embodiment of Formula II, Formula P-II, or Formula II-1, including any of the foregoing, R⁴ is hydrogen and R⁵ is unsubstituted phenyl. In one embodiment of Formula II, Formula P-II, or Formula II-1, including any of the foregoing, R⁴ is hydrogen and R⁵ is C₆₋₁₀aryl optionally substituted with one C₁₋₆alkyl group. In one embodiment of Formula II, Formula P-II, or Formula II-1, including any of the foregoing, R⁴ is hydrogen and R⁵ is C₆₋₁₀aryl optionally substituted with one methyl group. In one embodiment of Formula II, Formula P-II, or Formula II-1, including any of the foregoing, R⁴ is hydrogen and R⁵ is phenyl optionally substituted with one methyl group in the para position.

In one embodiment of Formula II, Formula P-II, or Formula II-1, including any of the foregoing, R⁴ is hydroxy and R$ is C₆₋₁₀aryl optionally substituted with one R⁷ group. In one embodiment of Formula II, Formula P-II, or Formula II-1, including any of the foregoing, R⁴ is hydroxy and R⁵ is unsubstituted C₆₋₁₀aryl. In one embodiment of Formula II, Formula P-II, or Formula II-1, including any of the foregoing, R⁴ is hydroxy and R⁵ is unsubstituted phenyl. In one embodiment of Formula II, Formula P-II, or Formula II-1, including any of the foregoing, R⁴ is hydroxy and R⁵ is C₆₋₁₀aryl optionally substituted with one C₁₋₆alkyl group. In one embodiment of Formula II, Formula P-II, or Formula II-1, including any of the foregoing, R⁴ is hydroxy and R⁵ is C₆₋₁₀aryl optionally substituted with one methyl group. In one embodiment of Formula II, Formula P-II, or Formula II-1, including any of the foregoing, R⁴ is hydroxy and R⁵ is phenyl optionally substituted with one methyl group in the para position.

In one embodiment of Formula II, Formula P-II, or Formula II-1, including any of the foregoing, R⁴ is C₁₋₆alkoxy and R⁵ is —CH₂C(O)OR⁶. In one embodiment of Formula II, Formula P-II, or Formula II-1, including any of the foregoing, R⁴ is C₁₋₆alkoxy and R⁵ is —CH₂C(O)OH. In one embodiment of Formula II, Formula P-II, or Formula II-1, including any of the foregoing, R⁴ is C₁₋₆alkoxy and R⁵ is —CH₂C(O)OC₁₋₆alkyl. In one embodiment of Formula II, Formula P-II, or Formula II-1, including any of the foregoing, R⁴ is C₁₋₆alkoxy and R⁵ is —CH₂C(O)OCH₃. In one embodiment of Formula II, Formula P-II, or Formula II-1, including any of the foregoing, R⁴ is methoxy and R⁵ is —CH₂C(O)OR⁶. In one embodiment of Formula II, Formula P-II, or Formula II-1, including any of the foregoing, R⁴ is methoxy and R⁵ is —CH₂C(O)OH. In one embodiment of Formula II, Formula P-II, or Formula II-1, including any of the foregoing, R⁴ is methoxy and R⁵ is —CH₂C(O)OC₁₋₆alkyl. In one embodiment of Formula II, Formula P-II, or Formula II-1, including any of the foregoing, R⁴ is methoxy and R⁵ is —CH₂C(O)OCH₃. In one embodiment of Formula II, Formula P-II, or Formula II-1, including any of the foregoing, R⁴ is ethoxy and R⁵ is —CH₂C(O)OR⁶. In one embodiment of Formula II, Formula P-II, or Formula II-1, including any of the foregoing, R⁴ is ethoxy and R⁵ is —CH₂C(O)OH. In one embodiment of Formula II, Formula P-II, or Formula II-1, including any of the foregoing, R⁴ is ethoxy and R⁵ is —CH₂C(O)OC₁₋₆alkyl. In one embodiment of Formula II, Formula P-II, or Formula II-1, including any of the foregoing, R⁴ is ethoxy and R⁵ is —CH₂C(O)OCH₃.

In one embodiment of Formula II or Formula P-II, R³, R⁴, and R⁵ together form a bridged C₃₋₁₀heterocycle that contains at least the —P—O—group to which R³, R⁴, and R⁵ are attached wherein the C₃₋₁₀heterocycle is optionally substituted with at least one R⁷ group. For example, in one embodiment, the compound of Formula II or Formula P-II is a compound of Formula IIA:

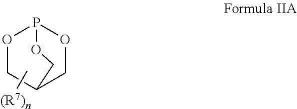

or a salt thereof, an anion thereof, a hydrolytic product thereof, or a reduction product thereof.

In one embodiment of Formula IIA, including any of the foregoing, n is 0. In one embodiment of Formula IIA, including any of the foregoing, n is 1. In one embodiment of Formula IIA, including any of the foregoing, n is 2.

In one embodiment of Formula IIA, including any of the foregoing, R⁷ is independently selected from C₁₋₆alkyl. In one embodiment of Formula IIA, including any of the foregoing, n is 1 and R⁷ is C₁₋₆alkyl. In one embodiment of Formula IIA, including any of the foregoing, n is 1 and R⁷ is ethyl.

In one embodiment of Formula II or Formula P-II, R³, R⁴, and R⁵ together form a spirocyclic C₃₋₁₀heterocycle that contains at least the —P(R⁵)O— group to which R³ and R⁴ are attached and wherein the spirocyclic C₃₋₁₀heterocycle is optionally substituted with at least one R⁷ group. For example, in one embodiment, the compound of Formula II or Formula II-P is a compound of Formula IIB:

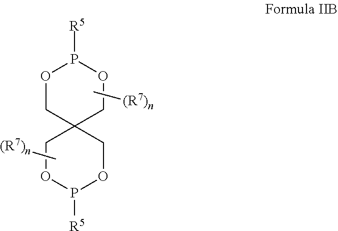

or a salt thereof, an anion thereof, a hydrolytic product thereof, or a reduction product thereof.

In one embodiment of Formula IIB, n is 0.

In one embodiment of Formula IIB, including any of the foregoing, R⁵ is independently selected from C₁₋₂₀alkoxy. In one embodiment of Formula IIB, including any of the foregoing, R⁵ is independently selected from C₁₀₋₂₀alkoxy. In one embodiment of Formula IIB, including any of the foregoing, R⁵ is independently selected from C₁₅₋₂₀alkoxy. In one embodiment of Formula IIB, including any of the foregoing, R⁵ is C₁₈alkoxy.

In one embodiment of Formula I, Formula P-I, Formula I-1, Formula I-2, Formula II, Formula P-II, Formula II-1, Formula II-2, Formula IA, Formula IB, or Formula IC, R⁷ is C₁₋₆alkyl. In one embodiment of Formula I, Formula P-I, Formula I-1, Formula I-2, Formula II, Formula P-II, Formula II-1, Formula II-2, Formula IA, Formula IB, or Formula IC, R⁷ is methyl. In one embodiment of Formula I, Formula P-I, Formula I-1, Formula I-2, Formula II, Formula P-II, Formula II-1, Formula II-2, Formula IA, Formula IB, or Formula IC, R⁷ is hydroxyC₁₋₆alkyl. In one embodiment of Formula I, Formula P-I, Formula I-1, Formula I-2, Formula II, Formula P-II, Formula II-1, Formula II-2, Formula IA, Formula IB, or Formula IC, R⁷ is —CH₂—OH. In one embodiment of Formula I, Formula I-1, Formula I-2, Formula II, Formula II-1, Formula II-2, Formula IA, Formula IB, or Formula IC, R⁷ is —OH.

In one embodiment of Formula I, Formula P-I, Formula I-1, Formula I-2, Formula II, Formula P-II, Formula II-1, Formula II-2, Formula IA, Formula IB, or Formula IC, R⁶ is C₁₋₆alkyl. In one embodiment of Formula I, Formula P-I, Formula I-1, Formula I-2, Formula II, Formula P-II, Formula II-1, Formula II-2, Formula IA, Formula IB, or Formula IC, R⁶ is methyl. In one embodiment of Formula I, Formula P-I, Formula I-1, Formula I-2, Formula II, Formula P-II, Formula II-1, Formula II-2, Formula IA, Formula IB, or Formula IC, R⁶ is hydrogen.

In one embodiment of Formula I, Formula P-I, or Formula I-1, including any of the foregoing, R¹ and R² are not both-OH.

In one embodiment of Formula I, Formula P-I, or Formula I-1, including any of the foregoing, the electrolyte additive is not phenylphosphoric acid.

In one embodiment of Formula P-I or Formula P-II, including any of the foregoing:
R¹ and R² are independently selected from hydrogen, —OH, C₁₋₆alkoxy, —CH₂C(O)OR⁶, and C₆₋₁₀aryl, wherein the C₆₋₁₀aryl is optionally substituted with at least one R⁷;
R³ is hydrogen or C₁₋₆alkyl; or
R¹ and R³ together form a C₃₋₁₀heterocycle that contains at least one oxygen atom; wherein the C₃₋₁₀heterocycle is optionally substituted with at least one R⁷ group; and/or
the C₃₋₁₀heterocycle is optionally fused to one or two C₆₋₁₀aryl groups; or
R¹, R², and R³ together form a bridged C₃₋₁₀heterocycle that contains at least one oxygen atom and wherein the C₃₋₁₀heterocycle is optionally substituted with at least one R⁷ group;
R⁴ and R⁵ are C₁₋₆alkoxy;
R⁶ is hydrogen or C₁₋₆alkyl; and
R⁷ is independently selected from C₁₋₆alkyl and hydroxyC₁₋₆alkyl.

In one embodiment of Formula P-I, Formula I, Formula I-1, or Formula I-2, including any of the foregoing,
R¹ is C₆₋₁₀aryl optionally substituted with at least one R⁷;
R² is selected from hydrogen, —OH, C₁₋₂₀alkoxy, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy wherein the C₆₋₁₀aryl, either alone or as part of another group, is optionally substituted with at least one R⁷; and
R³ is hydrogen, C₁₋₆alkyl, hydroxyC₁₋₆alkyl, C₆₋₁₀aryl, or C₆₋₁₀arylC₁₋₆alkyl, wherein the C₆₋₁₀aryl or the C₆₋₁₀arylC₁₋₆alkyl is optionally substituted with at least one R⁷.

In one embodiment of Formula P-I, Formula I, Formula I-1, or Formula I-2, including any of the foregoing,
R¹ is C₆₋₁₀aryl optionally substituted with at least one R⁷;
R² is selected from hydrogen, —OH, —C₁₋₆alkyl-C(O)OR⁶, C₆₋₁₀aryl, C₆₋₁₀aryloxy, and C₆₋₁₀arylC₁₋₆alkoxy wherein the C₆₋₁₀aryl, either alone or as part of another group, is optionally substituted with at least one R⁷; and
R³ is hydrogen, C₁₋₆alkyl, C₆₋₁₀aryl, or C₆₋₁₀arylC₁₋₆alkyl, wherein the C₆₋₁₀aryl or the C₆₋₁₀arylC₁₋₆alkyl is optionally substituted with at least one R⁷.

In one embodiment of Formula P-I, Formula I, Formula I-1, or Formula I-2, including any of the foregoing,
R¹ is C₆₋₁₀aryl optionally substituted with at least one R⁷;
R² is selected from hydrogen, —OH, —C₁₋₆alkyl-C(O)OR⁶, C₆₋₁₀aryl, C₆₋₁₀aryloxy, and C₆₋₁₀arylC₁₋₆alkoxy wherein the C₆₋₁₀aryl, either alone or as part of another group, is optionally substituted with at least one R⁷; and
R³ is hydrogen or C₁₋₆alkyl.

In one embodiment of Formula P-I, Formula I, Formula I-1, or Formula I-2, including any of the foregoing,
R¹ is C₆₋₁₀aryl optionally substituted with at least one R⁷;
R² is selected from hydrogen, —OH, —C₁₋₆alkyl-C(O)OR⁶, C₆₋₁₀aryl, C₆₋₁₀aryloxy, and C₆₋₁₀arylC₁₋₆alkoxy wherein the C₆₋₁₀aryl, either alone or as part of another group, is optionally substituted with at least one R⁷; and
R³ is hydrogen.

In one embodiment of Formula P-I, Formula I, Formula I-1, or Formula I-2, including any of the foregoing,
R¹ is C₆₋₁₀aryl optionally substituted with at least one R⁷;
R² is selected from hydrogen and —OH; and
R³ is hydrogen.

In one embodiment of Formula P-I, Formula I, Formula I-1, or Formula I-2, including any of the foregoing, the compound is of the formula:

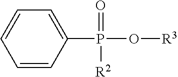

R² is selected from hydrogen, —OH, C₁₋₂₀alkoxy, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy wherein the C₆₋₁₀aryl, either alone or as part of another group, is optionally substituted with at least one R⁷; and
R³ is hydrogen, C₁₋₆alkyl, hydroxyC₁₋₆alkyl, C₆₋₁₀aryl, or C₆₋₁₀arylC₁₋₆alkyl, wherein the C₆₋₁₀aryl or the C₆₋₁₀arylC₁₋₆alkyl is optionally substituted with at least one R⁷.

In one embodiment of Formula P-I, Formula I, Formula I-1, or Formula I-2, including any of the foregoing, the compound is of the formula:

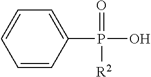

R² is selected from hydrogen, —OH, and C₁₋₂₀alkoxy, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy wherein the C₆₋₁₀aryl, either alone or as part of another group, is optionally substituted with at least one R⁷.

In one embodiment of Formula P-I, Formula I, Formula I-1, or Formula I-2, including any of the foregoing, the compound is of the formula:

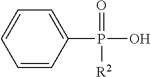

R² is selected from hydrogen, —OH, and —C₁₋₆alkyl-C(O)OR⁶.

In one embodiment of Formula P-I, Formula I, Formula I-1, or Formula I-2, including any of the foregoing, the compound is of the formula:

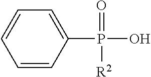

R² is selected from hydrogen and —OH.

In one embodiment of Formula P-I, Formula I, Formula I-1, or Formula I-2, including any of the foregoing, the compound is of the formula:

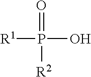

R¹ is selected from hydrogen, —OH, —C₁₋₆alkyl-C(O)OR⁶, C₆₋₁₀aryl, and C₆₋₁₀aryloxy wherein the C₆₋₁₀aryl, either alone or as part of another group, is optionally substituted with at least one R⁷; and
R² is selected from —C₁₋₆alkyl-C(O)OR⁶, C₆₋₁₀aryl, and C₆₋₁₀aryloxy wherein the C₆₋₁₀aryl, either alone or as part of another group, is optionally substituted with at least one R⁷.

In one embodiment of Formula P-I, Formula I, Formula I-1, or Formula I-2, including any of the foregoing, the compound is of the formula:

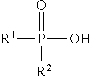

R¹ is selected from hydrogen and —OH; and
R² is C₆₋₁₀aryl optionally substituted with at least one R⁷.

In one embodiment of Formula P-I, Formula I, Formula I-1, or Formula I-2, including any of the foregoing, R³ is hydrogen, hydroxyC₁₋₆alkyl, C₆₋₁₀aryl, or C₆₋₁₀arylC₁₋₆alkyl, wherein the C₆₋₁₀aryl or the C₆₋₁₀arylC₁₋₆alkyl is optionally substituted with at least one R⁷.

In one embodiment of Formula P-I, Formula I-1, or Formula I-2, including any of the foregoing,
R¹ is hydrogen, —OH, C₁₋₆alkoxy, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy wherein the C₆₋₁₀aryl, either alone or as part of another group, is optionally substituted with at least one R⁷; and
R² is hydrogen, —OH, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy wherein the C₆₋₁₀aryl, either alone or as part of another group, is optionally substituted with at least one R⁷.

In one embodiment of Formula I, Formula I-1, or Formula I-2, including any of the foregoing,
R¹ is hydrogen, —OH, C₁₋₂₀alkoxy, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy wherein the C₆₋₁₀aryl, either alone or as part of another group, is optionally substituted with at least one R⁷; and
R² is hydrogen, —OH, C₅₋₂₀alkoxy, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy wherein the C₆₋₁₀aryl, either alone or as part of another group, is optionally substituted with at least one R⁷.

In one embodiment of Formula I or Formula P-I, Formula I-1, or Formula I-2, including any of the foregoing,
R¹ and R² are independently selected from hydrogen, —OH, C₆₋₁₀aryloxy, C₆₋₁₀aryl, C₆₋₁₀arylC₁₋₆alkoxy, and —C₁₋₆alkyl-C(O)OR⁶ wherein the C₆₋₁₀aryl, either alone or as part of another group, is optionally substituted with at least one R⁷;
R³ is selected from hydrogen, C₆₋₁₀aryl, C₁₋₆alkyl, C₆₋₁₀arylC₁₋₆alkyl wherein the C₆₋₁₀aryl or the C₆₋₁₀arylC₁₋₆alkyl is optionally substituted with at least one R⁷; and
R⁷ is independently selected from C₁₋₆alkyl and hydroxyC₁₋₆alkyl, and wherein R⁷ is not further substituted.

In one embodiment of Formula I or Formula P-I, Formula I-1, or Formula I-2, including any of the foregoing,
R¹ and R² are independently selected from hydrogen, —OH, and C₆₋₁₀aryl;
R³ is hydrogen; or
R¹ and R³ together form a C₃₋₁₀heterocycle that contains at least the —P(R²)(O)O— group to which R¹ and R³ are attached; wherein the C₃₋₁₀heterocycle is optionally substituted with at least one R⁷ group; and/or the C₃₋₁₀heterocycle is optionally fused to one or two C₆₋₁₀aryl groups; or
R¹, R², and R³ together form a bridged C₃₋₁₀heterocycle that contains at least the —P(O)O— group to which R¹, R², and R³ are attached wherein the C₃₋₁₀heterocycle is optionally substituted with at least one R⁷ group; and
R⁷ is independently selected from C₁₋₆alkyl and hydroxyC₁₋₆alkyl, and wherein R⁷ is not further substituted.

In one embodiment of Formula I or Formula P-I, Formula I-1, or Formula I-2, including any of the foregoing,
R¹ and R² are independently selected from hydrogen, —OH, and C₆₋₁₀aryl;
R³ is hydrogen; or
R¹ and R³ together form a C₃₋₁₀heterocycle that contains at least the —P(R²)(O)O— group to which R¹ and R³ are attached; wherein the C₃₋₁₀heterocycle is optionally substituted with at least one R⁷ group; and
R⁷ is independently selected from C₁₋₆alkyl and hydroxyC₁₋₆alkyl, and wherein R⁷ is not further substituted.

In one embodiment of Formula I or Formula P-I, Formula I-1, or Formula I-2, including any of the foregoing,
R¹ and R² are independently selected from hydrogen, —OH, C₆₋₁₀aryloxy, C₆₋₁₀aryl, C₆₋₁₀arylC₁₋₆alkoxy, and —C₁₋₆alkyl-C(O)OR⁶ wherein the C₆₋₁₀aryl, either alone or as part of another group, is optionally substituted with at least one R⁷;
R³ is selected from hydrogen, C₆₋₁₀aryl, C₁₋₆alkyl, C₆₋₁₀arylC₁₋₆alkyl wherein the C₆₋₁₀aryl or the C₆₋₁₀arylC₁₋₆alkyl is optionally substituted with at least one R⁷; or
R¹ and R³ together form a C₃₋₁₀heterocycle that contains at least the —P(R²)(O)O— group to which R¹ and R³ are attached; wherein the C₃₋₁₀heterocycle is optionally substituted with at least one R⁷ group; and/or the C₃₋₁₀heterocycle is optionally fused to one or two C₆₋₁₀aryl groups; or
R¹, R², and R³ together form a bridged C₃₋₁₀heterocycle that contains at least the —P(O)O— group to which R¹, R², and R³ are attached wherein the C₃₋₁₀heterocycle is optionally substituted with at least one R⁷ group; and
R⁷ is independently selected from C₁₋₆alkyl and hydroxyC₁₋₆alkyl, and wherein R⁷ is not further substituted.

In one embodiment, the aqueous electrolyte comprises an electrolyte additive selected from:

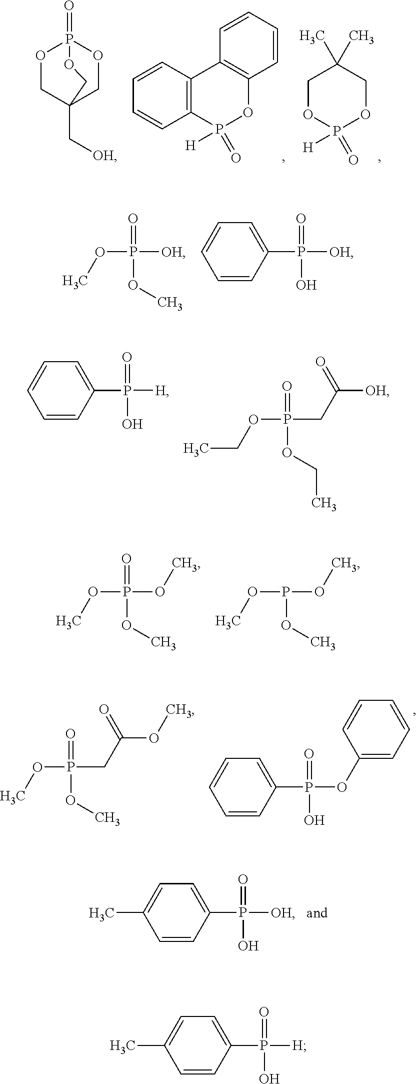

or a salt thereof, an anion thereof, hydrolytic product thereof, or an electrochemical reduction product thereof, or a combination thereof.

In one embodiment, the aqueous electrolyte comprises an electrolyte additive selected from:

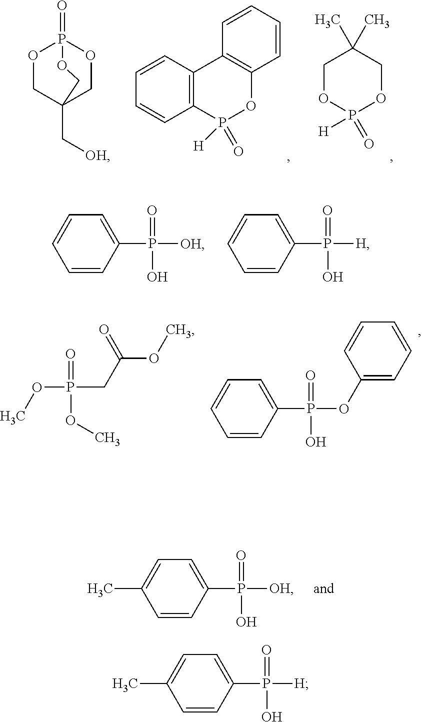

or a salt thereof, an anion thereof, hydrolytic product thereof, or an electrochemical reduction product thereof, or a combination thereof.

In one embodiment, the aqueous electrolyte comprises an electrolyte additive selected from:

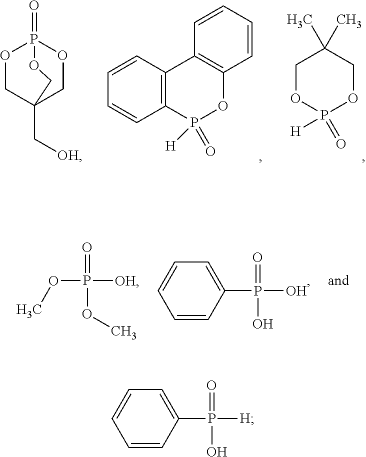

or a salt thereof, an anion thereof, hydrolytic product thereof, or an electrochemical reduction product thereof, or a combination thereof.

In one embodiment, the aqueous electrolyte comprises an electrolyte additive selected from:

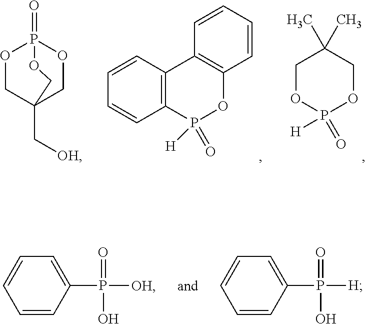

or a salt thereof, an anion thereof, hydrolytic product thereof, or an electrochemical reduction product thereof, or a combination thereof.

In one embodiment, the aqueous electrolyte comprises an electrolyte additive selected from:

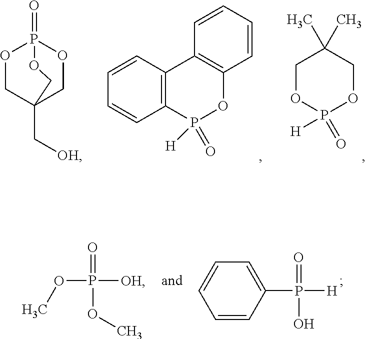

or a salt thereof, an anion thereof, hydrolytic product thereof, or an electrochemical reduction product thereof, or a combination thereof.

In one embodiment, the aqueous electrolyte comprises an electrolyte additive selected from:

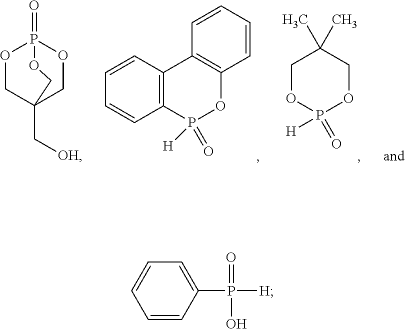

or a salt thereof, an anion thereof, hydrolytic product thereof, or an electrochemical reduction product thereof, or a combination thereof.

In one embodiment, the aqueous electrolyte comprises an electrolyte additive selected from:

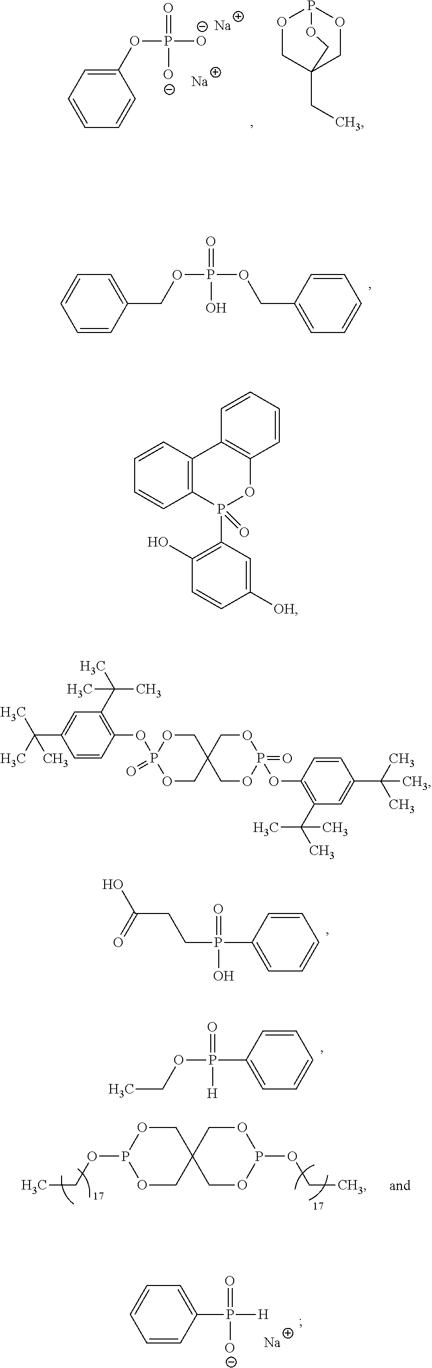

or a salt thereof, an anion thereof, hydrolytic product thereof, or an electrochemical reduction product thereof, or a combination thereof.

In one embodiment, including any of the foregoing, the aqueous electrolyte

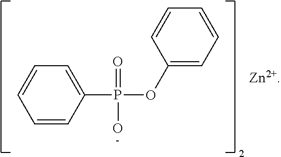

comprises an electrolyte additive of the formula:

In one embodiment, the aqueous electrolyte comprises at least two electrolyte additives selected from:

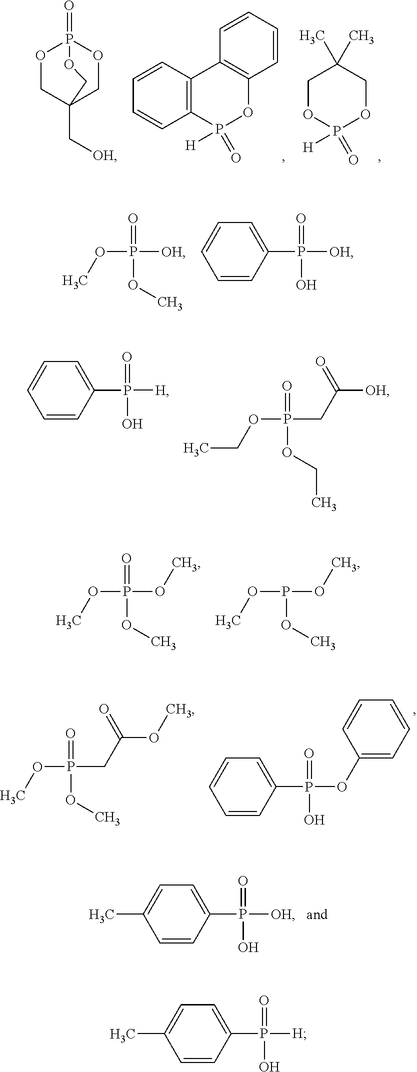

or a salt thereof, an anion thereof, hydrolytic product thereof, or an electrochemical reduction product thereof.

In one embodiment, the aqueous electrolyte comprises an electrolyte additive selected from:

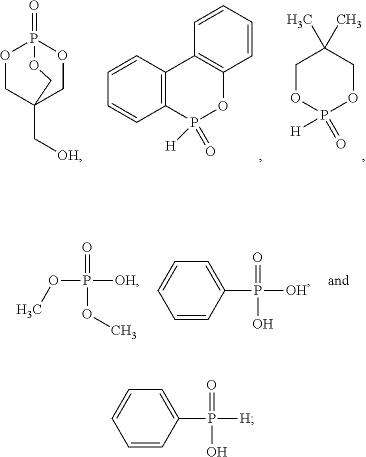

or a salt thereof, an anion thereof, hydrolytic product thereof, or an electrochemical reduction product thereof; and a second electrolyte additive selected from

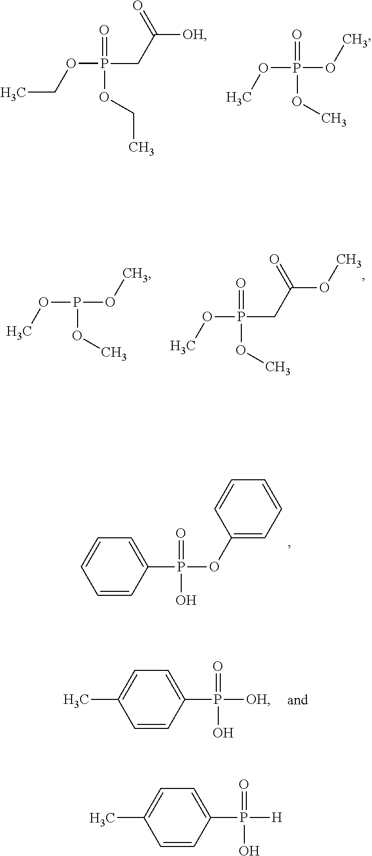

or a salt thereof, an anion thereof, hydrolytic product thereof, or an electrochemical reduction product thereof.

In one embodiment, the aqueous electrolyte comprises

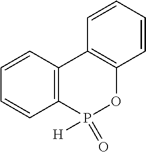 [SMILES: O=[PH]1Oc2ccccc2-c2ccccc21]

or a salt thereof, an anion thereof, hydrolytic product thereof, or an electrochemical reduction product thereof; and a second electrolyte additive selected from

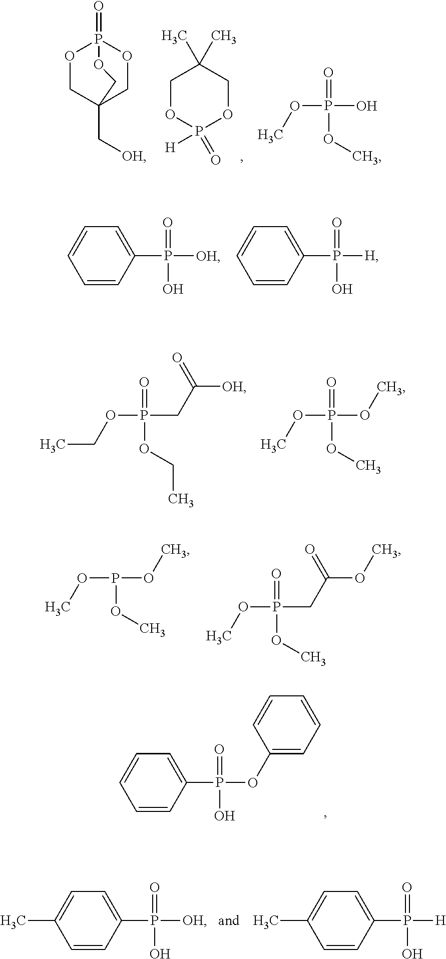

or a salt thereof, an anion thereof, hydrolytic product thereof, or an electrochemical reduction product thereof.

In one embodiment, the aqueous electrolyte comprises

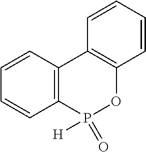 [SMILES: O=[PH]1Oc2ccccc2-c2ccccc21]

or a salt thereof, an anion thereof, hydrolytic product thereof, or an electrochemical reduction product thereof; and a second electrolyte additive selected from

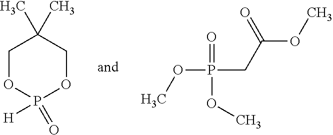

or a salt thereof, an anion thereof, hydrolytic product thereof, or an electrochemical reduction product thereof.

In one embodiment, the aqueous electrolyte comprises at least one electrolyte additive selected from:

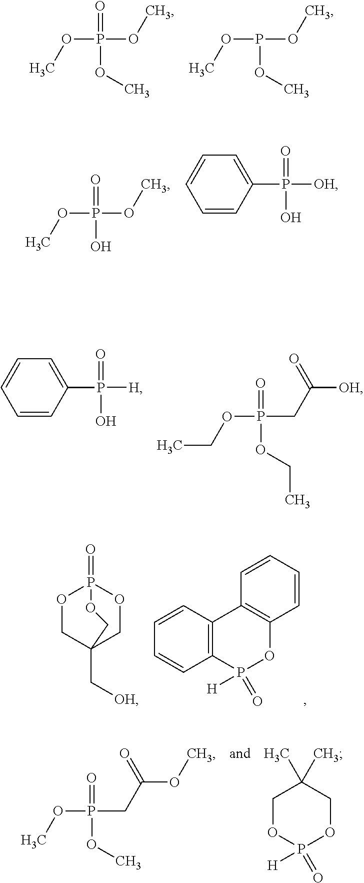

or a salt thereof, an anion thereof, hydrolytic product thereof, or an electrochemical reduction product thereof.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 0.05 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 0.1 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 0.5 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 1 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 5 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 10 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 15 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 20 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 30 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 40 weight percent (wt %) to less than, or equal to, 50 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 40 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 35 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 30 wt %.

In some examples, including any of the foregoing, the phosphorus electrolyte additive or combination of phosphorus electrolyte additives is present in the electrolyte at a concentration equal to, or greater than, about 1 weight percent (wt %) to less than, or equal to, 30 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 20 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 15 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 10 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 5 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 1 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 0.5 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 0.05 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 0.1 wt %.

In some examples, including any of the foregoing, the phosphorus electrolyte additive or combination of phosphorus electrolyte additives is present in the electrolyte at a concentration equal to, or greater than, about 0.001 weight percent (wt %) to less than, or equal to, 0.05 wt %.

In other examples, including any of the foregoing, the phosphorus electrolyte additive or combination of phosphorus electrolyte additives is present in the electrolyte at a concentration equal to, or greater than, about 0.1 weight percent (wt %) to less than, or equal to, 35 wt %.

In other examples, including any of the foregoing, the phosphorus electrolyte additive or combination of phosphorus electrolyte additives is present in the electrolyte at a concentration equal to, or greater than, about 0.1 weight percent (wt %) to less than, or equal to, 30 wt %.

In other examples, including any of the foregoing, the phosphorus electrolyte additive or combination of phosphorus electrolyte additives is present in the electrolyte at a concentration equal to, or greater than, about 0.1 weight percent (wt %) to less than, or equal to, 25 wt %.

In other examples, including any of the foregoing, the phosphorus electrolyte additive or combination of phosphorus electrolyte additives is present in the electrolyte at a concentration equal to, or greater than, about 0.1 weight percent (wt %) to less than, or equal to, 15 wt %.

In other examples, including any of the foregoing, the phosphorus electrolyte additive or combination of phosphorus electrolyte additives is present in the electrolyte at a concentration equal to, or greater than, about 0.1 weight percent (wt %) to less than, or equal to, 10 wt %.

In other examples, including any of the foregoing, the phosphorus electrolyte additive or combination of phosphorus electrolyte additives is present in the electrolyte at a concentration equal to, or greater than, about 0.5 weight percent (wt %) to less than, or equal to, 5 wt %.

In other examples, including any of the foregoing, the phosphorus electrolyte additive or combination of phosphorus electrolyte additives is present in the electrolyte at a concentration equal to, or greater than, about 0.5 weight percent (wt %) to less than, or equal to, 3 wt %.

In other examples, including any of the foregoing, the phosphorus electrolyte additive or combination of phosphorus electrolyte additives is present in the electrolyte at a concentration equal to, or greater than, about 0.5 weight percent (wt %) to less than, or equal to, 1 wt %.

In other examples, including any of the foregoing, the phosphorus electrolyte additive or combination of phosphorus electrolyte additives is present in the electrolyte at a concentration equal to, or greater than, about 0.5 weight percent (wt %) to less than, or equal to, 1.5 wt %.

In other examples, including any of the foregoing, the phosphorus electrolyte additive or combination of phosphorus electrolyte additives is present in the electrolyte at a concentration equal to, or greater than, about 0.01 weight percent (wt %) to less than, or equal to, 0.5 wt %.

In other examples, including any of the foregoing, the phosphorus electrolyte additive or combination of phosphorus electrolyte additives is present in the electrolyte at a concentration equal to, or greater than, about 0.1 weight percent (wt %) to less than, or equal to, 0.5 wt %.

In other examples, including any of the foregoing, the phosphorus electrolyte additive or combination of phosphorus electrolyte additives is present in the electrolyte at a concentration equal to, or greater than, about 1 weight percent (wt %) to less than, or equal to, 5 wt %.

In other examples, including any of the foregoing, the phosphorus electrolyte additive or combination of phosphorus electrolyte additives is present in the electrolyte at a concentration equal to, or greater than, about 1 weight percent (wt %) to less than, or equal to, 2 wt %.

In other examples, including any of the foregoing, the phosphorus electrolyte additive or combination of phosphorus electrolyte additives is present in the electrolyte at a concentration equal to, or greater than, about 0.001 weight percent (wt %) to less than, or equal to, 0.05 wt %.

In other examples, including any of the foregoing, the phosphorus electrolyte additive or combination of phosphorus electrolyte additives is present in the electrolyte at a concentration equal to, or greater than, about 0.001 weight percent (wt %) to less than, or equal to, 0.5 wt %.

In other examples, including any of the foregoing, the phosphorus electrolyte additive or combination of phosphorus electrolyte additives is present in the electrolyte at a concentration equal to, or greater than, about 0.01 weight percent (wt %) to less than, or equal to, 0.5 wt %.

In other examples, including any of the foregoing, the phosphorus electrolyte additive or combination of phosphorus electrolyte additives is present in the electrolyte at a concentration equal to, or greater than, about 0.01 weight percent (wt %) to less than, or equal to, 1 wt %.

In some examples, including any of the foregoing, the phosphorus electrolyte additive or combination of phosphorus electrolyte additives is present in the electrolyte at a concentration of about 50 weight percent (wt %).

In some examples, including any of the foregoing, the phosphorus electrolyte additive or combination of phosphorus electrolyte additives is present in the electrolyte at a concentration of about 40 weight percent (wt %).

In some examples, including any of the foregoing, the phosphorus electrolyte additive or combination of phosphorus electrolyte additives is present in the electrolyte at a concentration of about 30 weight percent (wt %).

In some examples, including any of the foregoing, the phosphorus electrolyte additive or combination of phosphorus electrolyte additives is present in the electrolyte at a concentration of about 25 weight percent (wt %).

In some examples, including any of the foregoing, the phosphorus electrolyte additive or combination of phosphorus electrolyte additives is present in the electrolyte at a concentration of about 20 weight percent (wt %).

In some examples, including any of the foregoing, the phosphorus electrolyte additive or combination of phosphorus electrolyte additives is present in the electrolyte at a concentration of about 15 weight percent (wt %).

In some examples, including any of the foregoing, the phosphorus electrolyte additive or combination of phosphorus electrolyte additives is present in the electrolyte at a concentration of about 10 weight percent (wt %).

In some examples, including any of the foregoing, the phosphorus electrolyte additive or combination of phosphorus electrolyte additives is present in the electrolyte at a concentration of about 5 weight percent (wt %).

In some examples, including any of the foregoing, the phosphorus electrolyte additive or combination of phosphorus electrolyte additives is present in the electrolyte at a concentration of about 4 weight percent (wt %).

In some examples, including any of the foregoing, the phosphorus electrolyte additive or combination of phosphorus electrolyte additives is present in the electrolyte at a concentration of about 3 weight percent (wt %).

In some examples, including any of the foregoing, the phosphorus electrolyte additive or combination of phosphorus electrolyte additives is present in the electrolyte at a concentration of about 2 weight percent (wt %).

In some examples, including any of the foregoing, the phosphorus electrolyte additive or combination of phosphorus electrolyte additives is present in the electrolyte at a concentration of about 1.5 weight percent (wt %).

In some examples, including any of the foregoing, the phosphorus electrolyte additive or combination of phosphorus electrolyte additives is present in the electrolyte at a concentration of about 1 weight percent (wt %).

In some examples, including any of the foregoing, the phosphorus electrolyte additive or combination of phosphorus electrolyte additives is present in the electrolyte at a concentration less than 0.5 weight percent (wt %).

In some examples, including any of the foregoing, the phosphorus electrolyte additive or combination of phosphorus electrolyte additives is present in the electrolyte at a concentration of about 0.5 weight percent (wt %).

In some examples, including any of the foregoing, the phosphorus electrolyte additive or combination of phosphorus electrolyte additives is present in the electrolyte at a concentration of about 0.1 weight percent (wt %).

In some examples, including any of the foregoing, the phosphorus electrolyte additive or combination of phosphorus electrolyte additives is present in the electrolyte at a concentration of about 0.05 weight percent (wt %).

In some examples, including any of the foregoing, the phosphorus electrolyte additive or combination of phosphorus electrolyte additives is present in the electrolyte at a concentration of about 0.01 weight percent (wt %).

In some examples, including any of the foregoing, the phosphorus electrolyte additive or combination of phosphorus electrolyte additives is present in the electrolyte at a concentration of about 0.005 weight percent (wt %).

In some examples, including any of the foregoing, the phosphorus electrolyte additive or combination of phosphorus electrolyte additives is present in the electrolyte at a concentration of about 0.001 weight percent (wt %).

In one embodiment, the aqueous electrolyte comprises two or more electrolyte additives and the concentration of each additive is between about 0.001 wt % and 10 wt %. In one embodiment, the aqueous electrolyte comprises two or more electrolyte additives and the combined concentration of the two or more additives is between about 0.001 wt % and 10 wt %.

In one embodiment, the aqueous electrolyte comprises two or more electrolyte additives and the concentration of each additive is between about 0.5 wt % and 5 wt %. In one embodiment, the aqueous electrolyte comprises two or more electrolyte additives and the combined concentration of the two or more additives is between about 0.5 wt % and 5 wt %.

In one embodiment, the aqueous electrolyte comprises two or more electrolyte additives and the concentration of each additive is between about 0.1 wt % and 1 wt %. In one embodiment, the aqueous electrolyte comprises two or more electrolyte additives and the combined concentration of the two or more additives is between about 0.1 wt % and 1 wt %.

In one embodiment, the aqueous electrolyte comprises two or more electrolyte additives and the concentration of each additive is between about 0.001 wt % and 0.5 wt %. In one embodiment, the aqueous electrolyte comprises two or more electrolyte additives and the combined concentration of the two or more additives is between about 0.001 wt % and 0.5 wt %.

In one embodiment, the aqueous electrolyte comprises two or more electrolyte additives and the concentration of each additive is about 10 wt %. In one embodiment, the aqueous electrolyte comprises two or more electrolyte additives and the combined concentration of the two or more additives is about 10 wt %.

In one embodiment, the aqueous electrolyte comprises two or more electrolyte additives and the concentration of each additive is about 5 wt %. In one embodiment, the aqueous electrolyte comprises two or more electrolyte additives and the combined concentration of the two or more additives is about 5 wt %.

In one embodiment, the aqueous electrolyte comprises two or more electrolyte additives and the concentration of each additive is about 1 wt %. In one embodiment, the aqueous electrolyte comprises two or more electrolyte additives and the combined concentration of the two or more additives is about 1 wt %.

In one embodiment, the aqueous electrolyte comprises two or more electrolyte additives and the concentration of each additive is about 0.5 wt %. In one embodiment, the aqueous electrolyte comprises two or more electrolyte additives and the combined concentration of the two or more additives is about 0.5 wt %.

In one embodiment, the aqueous electrolyte comprises two or more electrolyte additives and the concentration of each additive is about 0.1 wt %. In one embodiment, the aqueous electrolyte comprises two or more electrolyte additives and the combined concentration of the two or more additives is about 0.1 wt %.

In one embodiment, the aqueous electrolyte comprises two or more electrolyte additives and the concentration of each additive is about 0.01 wt %. In one embodiment, the aqueous electrolyte comprises two or more electrolyte additives and the combined concentration of the two or more additives is about 0.01 wt %.

In one embodiment, the aqueous electrolyte comprises two or more electrolyte additives and the concentration of each additive is about 0.001 wt %. In one embodiment, the aqueous electrolyte comprises two or more electrolyte additives and the combined concentration of the two or more additives is about 0.001 wt %.

In some examples, including any of the foregoing, the phosphorus electrolyte additive is of Formula P-I or Formula I-1 wherein R¹ and R² are independently selected from —OH and phenyl and R³ is H and the additive is present in the electrolyte at a concentration of about 0.001 weight percent (wt %) to 0.5 weight percent (wt %).

In some examples, including any of the foregoing, set forth herein is a zinc-battery or electrochemical cell comprising at least one electrolyte additive as set forth herein. In one embodiment, the battery comprises an anode wherein the anode is a metallic element, including but not limited to, zinc. In one embodiment, the battery comprises a zinc anode.

In some examples, including any of the foregoing, set forth herein is an electrochemical cell comprising an anode wherein the anode is a metallic element; a cathode selected from oxygen, lithium, carbon, cerium, chloride, bromide, iodide, iron, manganese dioxide, nickel, and silver oxide; and an aqueous electrolyte as set forth herein. In some examples, the anode is zinc.

In some examples, including any of the foregoing, set forth herein is an electrochemical cell comprising a zinc anode paired with a cathode of any of the following: lithium, carbon, chloride, bromide, iron, manganese dioxide, iodide, nickel, air, and silver oxide; and at least one phosphate electrolyte additive as set forth herein. In certain embodiments, the electrochemical cell comprises an anode selected from zinc-lithium, zinc-carbon, zinc-chloride, zinc-bromide, zinc-air, zinc-iron, zinc-manganese dioxide, zinc-iodide, zinc-nickel, or zinc-silver oxide; and at least one phosphate electrolyte additive as set forth herein.

In some examples, the zinc-battery comprises an aqueous electrolyte that comprises at least one additive as set forth herein and further comprises potassium hydroxide (KOH). In one embodiment, the pH of the aqueous electrolyte is about 8 to 13. In one embodiment, the pH of the aqueous electrolyte is about 10.

In some examples, the zinc-battery comprises an aqueous electrolyte that comprises at least one additive as set forth herein and further comprises zinc (II) sulfate.

### III. Process for Making

In some examples, set forth herein is a process for making a zinc battery, comprising contacting an aqueous electrolyte comprising an additive set forth herein with a zinc-battery electrode.

In some examples, including any of the foregoing, the zinc-battery comprises a positive electrode.

In some examples, including any of the foregoing, the zinc-battery comprises a negative electrode.

In some examples, including any of the foregoing, the negative electrode is selected from zinc foil, zinc powder, porous zinc, electroplated zinc, zinc alloy, or a combination thereof. In certain examples, the negative electrode is zinc foil. In certain examples, the negative electrode is zinc powder. In certain examples, the negative electrode is porous zinc. In certain other examples, the negative electrode is electroplated zinc. In certain examples, the negative electrode is zinc alloy. In certain examples, the negative electrode is a combination thereof zinc foil, zinc powder, porous zinc, electroplated zinc, and zinc alloy.

### IV. Methods for Using

Also described herein is a method of reducing or eliminating self-discharge and/or preventing hydrogen production, comprising:
providing an electrochemical cell comprising:
   (1) a zinc-lithium, zinc-carbon, zinc-chloride, zinc-bromide, zinc-air, zinc-iron, zinc-manganese dioxide, zinc-iodide, zinc-nickel, or zinc-silver oxide anode; and
   (2) an aqueous electrolyte comprising KOH and at least one electrolyte additive described here; and
   wherein the electrochemical cell is charged to 0.5 V or greater; and
   storing the electrochemical cell at 0° to 120° C. for at least one day;
   wherein the electrochemical cell voltage does not reduce by more than 10% during the storing.

In an alternative embodiment, the aqueous electrolyte comprises zinc (II) sulfate and at least one electrolyte additive described here.

In one embodiment, the electrochemical cell is charged to 1.0 V or greater.

In one embodiment, the electrochemical cell is charged to 1.5 V or greater.

In one embodiment, the electrochemical cell voltage does not reduce more than 8% during the storing.

In one embodiment, the electrochemical cell voltage does not reduce more than 5% during the storing.

### V. EXAMPLES

Chemicals were commercially purchased unless stated explicitly otherwise.

### Example 1—Effect of Phosphate Additives on Gas Formation

An electrolyte was created by mixing 10 milliliters of type I deionized water (measured to 18.2 megaohm [1,000Ω] resistance) with a mass of potassium hydroxide of either 3.09 grams (to create a 5.5 molar solution) or 4.48 grams (to create an 8.0 molar solution). An amount of additive was then added to the solution to achieve the concentrations listed in Tables 1A, 1B, IC, and ID. The electrolyte was then transferred to a 20-milliliter glass vial and 5 grams of dry zinc metal powder was added. The vial was then sealed using a cap with a Teflon septum and the cap was sealed using tape and vacuum grease. A plastic disposable syringe was inserted into the vial with a stainless-steel needle to measure the volume change of the vial. The vial was then held in an oven in ambient atmosphere and 60 degrees Celsius for fourteen days. The volume change (mL) was measured as displacement of the syringe plunger and assumed to be the gas generated from the electrolyte. The gas volume for the electrolytes made with 5.5 M KOH is shown in Table 1A and the gas volume for the electrolytes made with 8.0 M KOH is shown in Table 1B. In Table 1A and Table 1B, **** is 2 mL or greater; *** is greater than, or equal to, 1 mL but less than 2 mL; ** is greater than, or equal to, 0.5 mL but less than 1 mL; and * is less than 0.5 mL. As shown in Table 1A, the electrolyte made with 5.5 M of KOH and no additives produced a gas volume that was 2 mL or greater, but the addition of any additive from Table 1A lead to a production of gas volume that was less than 2 mL. All the representative additives shown in Table 1A produced less hydrogen gas compared to the electrolyte with no additive.

Similarly, as shown in Table 1B, the electrolyte made with 8.0 M of KOH and no additives produced a gas volume that was less than 2 mL, but greater than or equal to 1 mL. However, when a representative additive of Table 1B was added to the electrolyte, the gas production was reduced compared to the electrolyte with no additive. The gas production of the representative additives of Table 1B was greater than, or equal to, 0.5 mL, but less than 1 mL.

TABLE 1A
Gas volumes observed from zinc metal in electrolyte made with 5.5
M KOH after 14 days at 60° C. when various additives are present

| | Additive | |
|---|---|---|
| | Concentration | |
| Additive | (wt %) | Gas volume (mL) |
| None | N/A | **** |
| 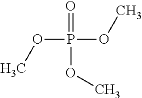 | 0.01% | ** |
| Trimethyl phosphate | | |
| 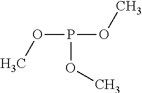 | 0.01% | *** |
| Trimethyl phosphite | | |
| 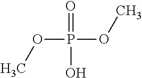 | 0.01% 1% | ** ** |
| Dimethyl phosphate | | |
| 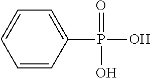 | 1% | ** |
| Phenylphosphonic acid | | |
| 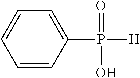 | 0.01% | *** |
| Phenylphosphinic acid | | |
| 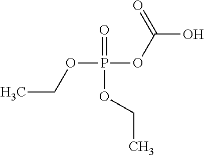 | 0.01% 1% | *** *** |
| Diethylphosphonoacetic acid | | |
| 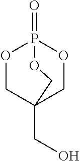 [SMILES: O=P12OCC(CO)(CO1)CO2] | 1% | *** |
| 4-Hydroxymethyl-2,6,7- | | |
| trioxa-1-phospha- | | |
| bicyclo[2.2.2]octane 1-Oxide | | |
| 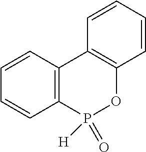 [SMILES: O=[PH]1Oc2ccccc2-c2ccccc21] | 0.01% 1% | ** |
| 9,10-Dihydro-9-oxa-10- | | |
| phosphaphenanthrene 10- | | |
| oxide | | |
| 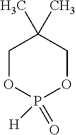 | 0.01% 1% | ** ** |
| 5,5-Dimethyl-1,3,2- | | |
| dioxaphosphorinan-2-one | | |

TABLE 1B
Gas volumes observed from zinc metal in electrolyte made with 8.0
M KOH after 14 days at 60° C. when various additives are present.

| | Additive | Gas volume |
|---|---|---|
| Additive | Concentration (wt %) | (mL) |
| | N/A | *** |
| 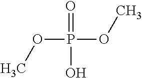 | 1% | ** |
| Dimethyl phosphate | | |
| 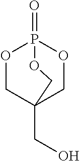 [SMILES: O=P12OCC(CO)(CO1)CO2] | 1% | ** |
| 4-Hydroxymethyl-2,6,7- | | |
| trioxa-1-phospha- | | |
| bicyclo[2.2.2]octane 1-Oxide | | |

Additional data produced by an improved testing method that improved accuracy is shown in Table 1C and Table 1D. The gas volume for the electrolytes made with 5.5 M KOH is shown in Table 1C and the gas volume for the electrolytes made with 8.0 M KOH is shown in Table 1D. In Table 1C **** is 1.5 mL or greater; *** is greater than, or equal to, 0.5 mL but less than 1.5 mL; ** is greater than, or equal to, 0.2 mL but less than 0.5 mL; and * is less than 0.2 mL. In Table 1D **** is greater than 0.5 mL; *** is greater than, 0.25 mL but less than or equal to 0.5 mL; ** is greater than 0.1 mL but less than or equal to 0.25 mL; and * is less than or equal to 0.1 mL. Certain compounds from Table 1A and 1B are repeated in Tables 1C and 1D, respectively.

TABLE 1C
Gas volumes observed from zinc metal in electrolyte made with 5.5
M KOH after 14 days at 60° C. when various additives are present

| | Additive | Gas |
|---|---|---|
| | Concentration | volume |
| Additive | (wt %) | (mL) |
| None | N/A | **** |
| Polyoxyethylene dinonylphenyl ether | 0.004% | *** |
| phosphate (industry standard) | (solubility limit) | |
| 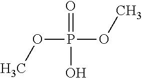 | 1% | * |
| Dimethyl Phosphate | | |
| 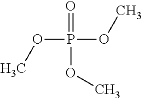 | 1% | ** |
| Trimethyl Phosphate | | |
| 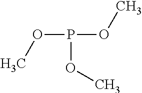 | 1% | *** |
| Trimethyl Phosphite | | |
| 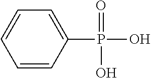 | 30% 1% 0.01% | ** ** * |
| Phenylphosphonic acid | | |
| 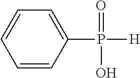 | 20% 1% 0.01% 0.005% | * * * * |
| Phenylphosphinic acid | | |
| 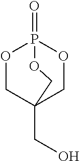 [SMILES: O=P12OCC(CO)(CO1)CO2] | 10% 1% 0.01% 0.001% | ** ** ** ** |
| 4-Hydroxymethyl-2,6,7-trioxa-1-phospha- | | |
| bicyclo[2.2.2]octane 1-Oxide | | |
| 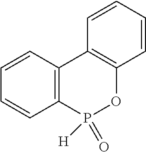 [SMILES: O=[PH]1Oc2ccccc2-c2ccccc21] | 0.01% 15% | ** * |
| 9,10-Dihydro-9-oxa-10-phosphaphenanthrene | | |
| 10-oxide | | |
| 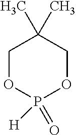 | 0.1% 0.01% 0.01% | * * *** |
| 5,5-Dimethyl-1,3,2-dioxaphosphorinan-2-one | | |
| 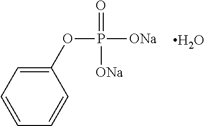 | 1% | ** |
| Phenyl phosphate disodium salt dihydrate | | |
| 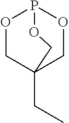 | 0.01% 1% | * *** |
| Trimethylolpropane Phosphite | | |
| 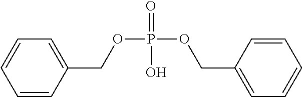 [SMILES: O=P(O)(OCc1ccccc1)OCc1ccccc1] | 0.01% 1% | *** * |
| Dibenzyl phosphate | | |
| 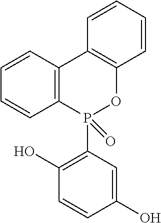 [SMILES: O=P1(c2cc(O)ccc2O)Oc2ccccc2-c2ccccc21] | 0.01% 0.001% 0.1% | * * *** |
| 6-(2,5-Dihydroxyphenyl)-6H- | | |
| dibenz[c,e][1,2]oxaphosphorine-6-oxide | | |
| 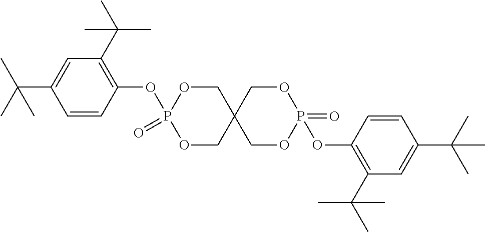 [SMILES: CC(C)(C)c1ccc(OP2(=O)OCC3(CO2)COP(=O)(Oc2ccc(C(C)(C)C)cc2C(C)(C)C)OC3)c(C(C)(C)C)c1] | 10% | *** |
| Bis(2,4-di-tert-butylphenyl)-pentaerythritol | | |
| diphosphite | | |
| 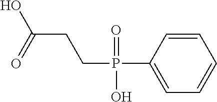 [SMILES: O=C(O)CCP(=O)(O)c1ccccc1] | 0.1% 0.001% 0.1% | *** * *** |
| (2-Carboxyethyl) phenylphosphinic acid | | *** |
| 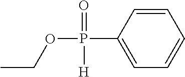 | 1% | * |
| Ethyl phenylphosphinate | | |
| 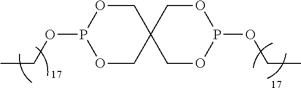 | 0.1% | *** |
| 3,9-Bis(octadecyloxy)-2,4,8, 10-tetraoxa-3,9- | | |
| diphosphaspiro[5.5]undecane | | |
| 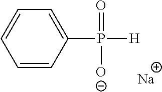 | | |
| Phenylphosphinic acid (Sodium) | | |

TABLE 1D
Gas volumes observed from zinc metal in electrolyte made with 8.0
M KOH after 14 days at 60° C. when various additives are present.

| | Additive | Gas |
|---|---|---|
| | Concentration | volume |
| Additive | (wt %) | (mL) |
| None | N/A | **** |
| 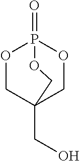 [SMILES: O=P12OCC(CO)(CO1)CO2] | 1% | * |
| 4-Hydroxymethyl-2,6,7- | | |
| trioxa-1-phospha- | | |
| bicyclo[2.2.2]octane 1-Oxide | | |
| 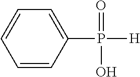 | 1% | * |
| Phenylphosphinic Acid | | |
| 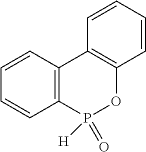 [SMILES: O=[PH]1Oc2ccccc2-c2ccccc21] | 1% | * |
| 9,10-Dihydro-9-oxa-10- | | |
| phosphaphenanthrene 10- | | |
| Oxide | | |
| 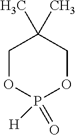 | 1% | *** |
| 5,5-Dimethyl-1,3,2- | | |
| dioxaphosphorinan-2-one | | |

### Example 2—Effect of Phosphorous Additives on Corrosion Inhibition Efficiency

The control electrolyte was created by mixing 60 mL of type I deionized water (measured to 18.2 megaohm [1,000Ω] resistance) with either 18.5 g of potassium hydroxide (KOH) (to create a 5.5 molar solution), 26.9 g of potassium hydroxide (to create an 8.0 molar solution), or 21.5 g of zinc sulfate monohydrate (to create a 2.0 molar solution), and 0.486 g of zinc oxide (ZnO). To the control electrolyte, an amount of additive was then added to the solution to achieve the concentrations listed in Tables 2A, 2B, and 2C. The resulting electrolyte was sparged using industrial grade nitrogen for 45 minutes. To determine the effectiveness of the additive in suppressing the corrosion of zinc in the KOH electrolyte, Tafel scans were performed using an electrochemical cell in a three-electrode configuration. Experiments were performed both in the presence and absence of the additive. A 1 mm diameter Zn wire (99.95% purity, Thermo Scientific), coated with AquaMend underwater repair epoxy was used as the working electrode (WE). Prior to each experiment the tip of epoxy coated zinc wire WEs were sanded with 1000 grit sandpaper, then polished with 5 μm alumina slurry (Aztron Technologies) on a terry cloth polishing pad (Grainger). A Hg/HgO electrode filled with 4.24 molar KOH was used as the reference electrode (E_{Hg/HgO}=+0.098 V vs Normal Hydrogen Electrode (NHE)). A 0.5 mm diameter platinum wire (Sigma-Aldrich) was used as the counter electrode. All electrochemical measurements were performed with BioLogic SP-300 potentiostat at room temperature. The corrosion inhibition efficiency (ηp) of the additive was given as

$${η}_{p} = \frac{{i}_{corr} - {i}_{corr}^{′}}{{i}_{corr}} , \qquad ( Eq . 1 )$$

where, i_{corr} and i_{corr}′ were the corrosion current densities of zinc with and without the additive in the electrolyte. For Tables 2A, 2B and 2C, **** is less than 20%, *** is greater than 20% but less than or equal to 40%, ** is greater than 40% but less than or equal to 60%, and * is greater than 60%.

EXAMPLE 2A. EFFECT OF 9,10-DIHYDRO-9-OXA-10-PHOSPHAPHENANTHRENE-10-OXIDE (100 ppm) ON CORROSION INHIBITION EFFICIENCY The control electrolyte was created by mixing 60 ml of type I deionized water (measured to 18.2 megaohm resistance) with 18.5 g of potassium hydroxide (KOH) and 0.486 g of zinc oxide (ZnO). To the control electrolyte, 6 mg of 9,10-dihydro-9-oxa-10-phosphaphenanthrene 10-oxide was added. The resulting electrolyte was sparged using industrial grade nitrogen for 45 minutes. To determine the effectiveness of the additive in suppressing the corrosion of zinc in the KOH electrolyte, Tafel scans were performed using an electrochemical cell in a three-electrode configuration. Experiments were performed both in the presence and absence of the additive. A 1 mm diameter Zn wire (99.95% purity, Thermo Scientific), coated with AquaMend underwater repair epoxy was used as the working electrode (WE). Prior to each experiment the tip of epoxy coated zinc wire WEs were sanded with 1000 grit sandpaper, then polished with 5 μm alumina slurry (Aztron Technologies) on a terry cloth polishing pad (Grainger). A Hg/HgO electrode filled with 4.24 molar KOH was used as the reference electrode (E_{Hg/HgO}=+0.098 V vs Normal Hydrogen Electrode (NHE)). A 0.5 mm diameter platinum wire (Sigma-Aldrich) was used as the counter electrode. All electrochemical measurements were performed with BioLogic SP-300 potentiostat at room temperature. The corrosion inhibition efficiency (ηₚ) of the additive was given as

$${η}_{p} = \frac{{i}_{corr} - {i}_{corr}^{′}}{{i}_{corr}} , \qquad ( Eq . 1 )$$

where, i_{corr} and i_{corr}′ were the corrosion current densities of zinc with and without the additive in the electrolyte. At 100 parts per million (ppm) additive concentration, np for 9,10-Dihydro-9-oxa-10-phosphaphenanthrene 10-oxide is shown in Table 2A.

EXAMPLE 2B. EFFECT OF 4-HYDROXYMETHYL-2,6,7-TRIOXA-1-PHOSPHABICYCLO [2.2.2] OCTANE 1-OXIDE (1%) ON CORROSION INHIBITION EFFICIENCY The control electrolyte was created by mixing 60 ml of type I deionized water (measured to 18.2 megaohm resistance) with 18.5 g of potassium hydroxide (KOH) and 0.486 g of zinc oxide (ZnO). To the control electrolyte, 0.6 g of 4-Hydroxymethyl-2,6,7-trioxa-1-phosphabicyclo[2.2.2] octane 1-oxide was added. The resulting electrolyte was sparged using industrial grade nitrogen for 45 minutes. To determine the effectiveness of the additive in suppressing the corrosion of zinc in the KOH electrolyte, Tafel scans were performed using an electrochemical cell in a three-electrode configuration. Experiments were performed both in the presence and absence of the additive. A 1 mm diameter Zn wire (99.95% purity, Thermo Scientific), coated with AquaMend underwater repair epoxy was used as the working electrode (WE). Prior to each experiment the tip of epoxy coated zinc wire WEs were sanded with 1000 grit sandpaper, then polished with 5 μm alumina slurry (Aztron Technologies) on a terry cloth polishing pad (Grainger). A Hg/HgO electrode filled with 4.24 molar KOH was used as the reference electrode (E_{Hg/HgO}=+0.098 V vs Normal Hydrogen Electrode (NHE)). A 0.5 mm diameter platinum wire (Sigma-Aldrich) was used as the counter electrode. All electrochemical measurements were performed with BioLogic SP-300 potentiostat at room temperature. The corrosion inhibition efficiency (ηₚ) of the additive was given as in Equation 1. At 1% additive concentration, np for 4-Hydroxymethyl-2,6,7-trioxa-1-phosphabicyclo[2.2.2]octane 1-oxide was measured as in Table 2A.

EXAMPLE 2C. EFFECT OF ETHYL PHENYLPHOSPHINATE (1000 ppm) ON CORROSION INHIBITION EFFICIENCY The control electrolyte was created by mixing 60 ml of type I deionized water (measured to 18.2 megaohm resistance) with 18.5 g of potassium hydroxide (KOH) and 0.486 g of zinc oxide (ZnO). To the control electrolyte, 0.06 g of ethyl phenylphosphinate was added. The resulting electrolyte was sparged using industrial grade nitrogen for 45 minutes. To determine the effectiveness of the additive in suppressing the corrosion of zinc in the KOH electrolyte, Tafel scans were performed using an electrochemical cell in a three-electrode configuration. Experiments were performed both in the presence and absence of the additive. A 1 mm diameter Zn wire (99.95% purity, Thermo Scientific), coated with AquaMend underwater repair epoxy was used as the working electrode (WE). Prior to each experiment the tip of epoxy coated zinc wire WEs were sanded with 1000 grit sandpaper, then polished with 5 μm alumina slurry (Aztron Technologies) on a terry cloth polishing pad (Grainger). A Hg/HgO electrode filled with 4.24 molar KOH was used as the reference electrode (E_{Hg/HgO}=+0.098 V vs Normal Hydrogen Electrode (NHE)). A 0.5 mm diameter platinum wire (Sigma-Aldrich) was used as the counter electrode. All electrochemical measurements were performed with BioLogic SP-300 potentiostat at room temperature. The corrosion inhibition efficiency (ηₚ) of the additive was given as in Equation 1. At 1000 parts per million (ppm) additive concentration, ηₚ for ethyl phenylphosphinate was measured as shown in Table 2A.

EXAMPLE 2D. EFFECT OF 5,5-DIMETHYL-1,3,2-DIOXAPHOSPHORINAN-2-ONE (1%) ON CORROSION INHIBITION EFFICIENCY The control electrolyte was created by mixing 60 ml of type I deionized water (measured to 18.2 megaohm resistance) with 26.88 g of potassium hydroxide (KOH) and 0.486 g of zinc oxide (ZnO). To the control electrolyte, 0.6 g of 5,5-Dimethyl-1,3,2-dioxaphosphorinan-2-one was added. The resulting electrolyte was sparged using industrial grade nitrogen for 45 minutes. To determine the effectiveness of the additive in suppressing the corrosion of zinc in the KOH electrolyte, Tafel scans were performed using an electrochemical cell in a three-electrode configuration. Experiments were performed both in the presence and absence of the additive. A 1 mm diameter Zn wire (99.95% purity, Thermo Scientific), coated with AquaMend underwater repair epoxy was used as the working electrode (WE). Prior to each experiment the tip of epoxy coated zinc wire WEs were sanded with 1000 grit sandpaper, then polished with 5 μm alumina slurry (Aztron Technologies) on a terry cloth polishing pad (Grainger). A Hg/HgO electrode filled with 4.24 molar KOH was used as the reference electrode (E_{Hg/HgO}=+0.098 V vs Normal Hydrogen Electrode (NHE)). A 0.5 mm diameter platinum wire (Sigma-Aldrich) was used as the counter electrode. All electrochemical measurements were performed with BioLogic SP-300 potentiostat at room temperature. The corrosion inhibition efficiency (ηₚ) of the additive was given as in Equation 1. At 1% additive concentration, np for 5,5-Dimethyl-1,3,2-dioxaphosphorinan-2-one was measured as shown in Table 2A.

EXAMPLE 2E. EFFECT OF 4-HYDROXYMETHYL-2,6,7-TRIOXA-1-PHOSPHABICYCLO [2.2.2] OCTANE 1-OXIDE (1%) ON CORROSION INHIBITION EFFICIENCY The control electrolyte was created by mixing 60 ml of type I deionized water (measured to 18.2 megaohm with 21.5 g of zinc sulfate mono hydrate (ZnSO₄). To the control electrolyte, 0.6 g of 4-Hydroxymethyl-2,6,7-trioxa-1-phosphabicyclo[2.2.2]octane 1-oxide was added. The resulting electrolyte was sparged using industrial grade nitrogen for 45 minutes. To determine the effectiveness of the additive in suppressing the corrosion of zinc in the ZnSO₄ electrolyte, Tafel scans were performed using an electrochemical cell in a three-electrode configuration. Experiments were performed both in the presence and absence of the additive. A 1 mm diameter Zn wire (99.95% purity, Thermo Scientific), coated with AquaMend underwater repair epoxy was used as the working electrode (WE). Prior to each experiment the tip of epoxy coated zinc wire WEs were sanded with 1000 grit sandpaper, then polished with 5 μm alumina slurry (Aztron Technologies) on a terry cloth polishing pad (Grainger). An Ag/AgCl electrode filled with 4 molar potassium chloride (KCl) gel was used as the reference electrode (E_{Ag/AgCl}=+0.199 V vs Normal Hydrogen Electrode (NHE)). A 0.5 mm diameter platinum wire (Sigma-Aldrich) was used as the counter electrode. All electrochemical measurements were performed with BioLogic SP-300 potentiostat at room temperature. The corrosion inhibition efficiency (ηₚ) of the additive was given as in Equation 1. At 1% additive concentration, ηₚ for 4-hydroxymethyl-2,6,7-trioxa-1-phosphabicyclo[2.2.2]octane 1-oxide was measured as shown in Table 2C.

TABLE 2A
Corrosion inhibition efficiencies observed as defined above in
electrolyte of 5.5 M KOH when various additives are present.

| | Additive | |
|---|---|---|
| | Concentration | |
| Additive Name | (wt %) | ηₚ (%) |
| None | | **** (0%) |
| Polyoxyethylene dinonylphenyl ether phosphate | 0.004% | *** |
| (industry standard) | | |
| 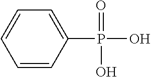 | 1% 0.01% | *** ** |
| Phenylphosphonic Acid | | |
| 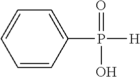 | 1% 0.01% | ** ** |
| Phenylphosphinic Acid | | |
| 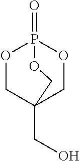 [SMILES: O=P12OCC(CO)(CO1)CO2] | 1% 0.1% 0.001% | *** ** * |
| 4-Hydroxymethyl-2,6,7-trioxa-1-phosphabicyclo [2.2.2] | | |
| octane 1-Oxide | | |
| 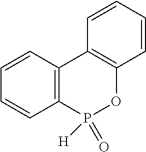 [SMILES: O=[PH]1Oc2ccccc2-c2ccccc21] | 20% 10% 1% 0.01% | * *** *** ** |
| 9,10-Dihydro-9-oxa-10-phosphaphenanthrene 10-Oxide | | |
| 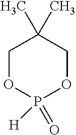 | 1% 0.1% 0.01% | *** * ** |
| 5,5-Dimethyl-1,3,2-dioxaphosphorinan-2-one | | |
| 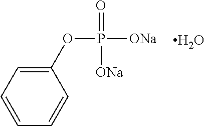 | 1% | *** |
| Phenyl phosphate disodium salt dihydrate | | |
| 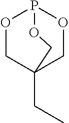 | 0.1% | *** |
| Trimethylolpropane Phosphite | | |
| 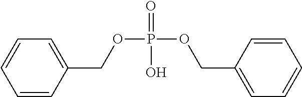 [SMILES: O=P(O)(OCc1ccccc1)OCc1ccccc1] | 0.01% | ** |
| Dibenzyl phosphate | | |
| 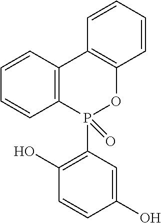 [SMILES: O=P1(c2cc(O)ccc2O)Oc2ccccc2-c2ccccc21] | 0.01% 1% | ** *** |
| 6-(2,5-Dihydroxyphenyl)-6H- | | |
| dibenz[c,e][1,2]oxaphosphorine-6-oxide | | |
| 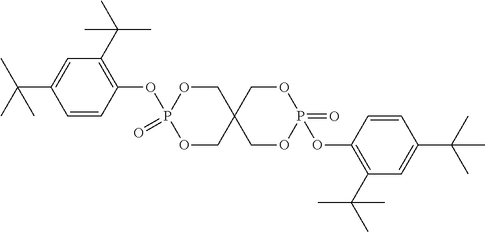 [SMILES: CC(C)(C)c1ccc(OP2(=O)OCC3(CO2)COP(=O)(Oc2ccc(C(C)(C)C)cc2C(C)(C)C)OC3)c(C(C)(C)C)c1] | 0.1% | * |
| Bis(2,4-di-tert-butylphenyl)- pentaerythritol | | |
| diphosphate | | |
| 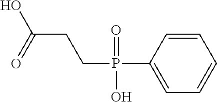 [SMILES: O=C(O)CCP(=O)(O)c1ccccc1] | 0.1% | *** |
| (2-carboxyethyl)phenylphosphinic Acid | | |
| 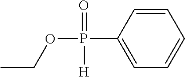 | 0.1% | |
| Ethyl phenylphosphinate | | |
| 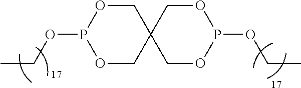 | 1% | *** |
| 3,9-Bis(octadecyloxy)-2,4,8,10-tetraoxa-3,9- | | |
| diphosphaspiro[5.5]undecane | | |
| 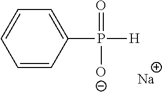 | 0.1% | * |
| Phenylphosphinic acid (Sodium) | | |

TABLE 2B
Corrosion inhibition efficiencies observed as defined above in
electrolyte of 8.0 M KOH when various additives are present.

| | Additive | |
|---|---|---|
| | Concentration | |
| Additive Name | (wt %) | ηₚ (%) |
| None | | **** (0%) |
| 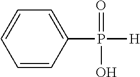 | 1% | *** |
| Phenylphosphinic Acid | | |
| 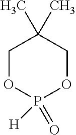 | 1% | *** |
| 5,5-Dimethyl-1,3,2-dioxaphosphorinan-2-one | | |

TABLE 2C
Corrosion inhibition efficiencies observed as defined above in
electrolyte of 2.0 M Zinc (II) Sulfate when various additives are present.

| | Additive | |
|---|---|---|
| | Concentration | |
| Additive Name | (wt %) | ηₚ (%) |
| None | | **** (0%) |
| 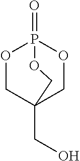 [SMILES: O=P12OCC(CO)(CO1)CO2] | 1% | * |
| 4-Hydroxymethyl-2,6,7-trioxa-1- | | |
| phosphabicyclo[2.2.2]octane 1-Oxide | | |

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1-78. (canceled)

79. An aqueous electrolyte comprising at least one electrolyte additive of Formula I: 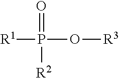
or a salt thereof, anion thereof, hydrolytic product thereof, or electrochemical reduction product thereof;
wherein
R¹ is C₆₋₁₀aryl optionally substituted with at least one R⁷;
R² is selected from the group consisting of hydrogen, —OH, C₁₋₂₀alkoxy, —C₁₋₆alkyl-C(O)OR⁶, hydroxyC₁₋₆alkyl, C₆₋₁₀aryl, C₆₋₁₀arylC₁₋₆alkyl, C₆₋₁₀aryloxy, and C₆₋₁₀arylC₁₋₆alkoxy, wherein the C₆₋₁₀aryl, either alone or as part of another group, is optionally substituted with at least one R⁷; and
R³ is hydrogen, C₁₋₆alkyl, hydroxyC₁₋₆alkyl, C₆₋₁₀aryl, or C₆₋₁₀arylC₁₋₆alkyl, wherein the C₆₋₁₀aryl or the C₆₋₁₀arylC₁₋₆alkyl is optionally substituted with at least one R⁷;
R⁶ is hydrogen or C₁₋₆alkyl;
R⁷ is independently selected from the group consisting of C₁₋₆alkyl, —OH, and hydroxyC₁₋₆alkyl, and wherein R⁷ is not further substituted;
wherein the aqueous electrolyte optionally further comprises an ion selected from the group consisting of Na⁺, K⁺, Ca²⁺, Zn²⁺, a quaternary ammonium cation, and combinations thereof; and
wherein the aqueous electrolyte has a pH greater than about 7;
wherein the at least one electrolyte additive is present in a solvent in the aqueous electrolyte, wherein water is the only solvent, at a concentration equal to, or greater than, 0.001 weight percent (wt %) to less than 5 wt %.

80. The aqueous electrolyte of claim 79,
wherein
R² is selected from the group consisting of hydrogen, —OH, —C₁₋₆alkyl-C(O)OR⁶, C₆₋₁₀aryl, C₆₋₁₀aryloxy, and C₆₋₁₀arylC₁₋₆alkoxy, wherein the C₆₋₁₀aryl, either alone or as part of another group, is optionally substituted with at least one R⁷, and
R³ is hydrogen or C₁₋₆alkyl.

81. The aqueous electrolyte of claim 79, wherein R³ is hydrogen.

82. The aqueous electrolyte of claim 79, wherein R² is selected from hydrogen or —OH.

83. The aqueous electrolyte of claim 79, of the formula:

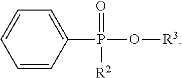

84. The aqueous electrolyte of claim 83, of the formula:

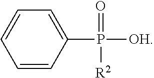

85. The aqueous electrolyte of claim 84, wherein R² is selected from the group consisting of hydrogen, —OH, and —C₁₋₆alkyl-C(O)OR⁶.

86. The aqueous electrolyte of claim 84, wherein R² is hydrogen or —OH.

87. The aqueous electrolyte of claim 79, wherein the electrolyte comprises the cation K⁺.

88. The aqueous electrolyte of claim 79, wherein the electrolyte additive is selected from the group consisting of 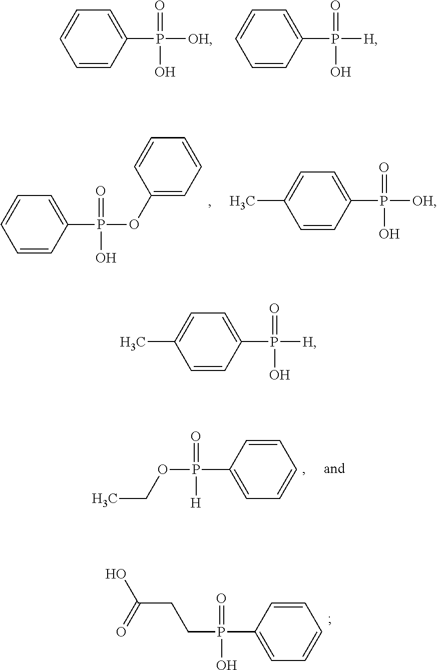
or a salt thereof, an anion thereof, a hydrolytic product thereof, or an electrochemical reduction product thereof.

89. The aqueous electrolyte of claim 79, wherein the electrolyte additive is selected from the group consisting of 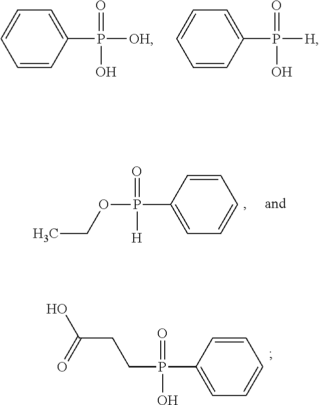
or a salt thereof, an anion thereof, a hydrolytic product thereof, or an electrochemical reduction product thereof.

90. The aqueous electrolyte of claim 89, wherein the electrolyte additive is 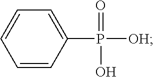
or a salt thereof, an anion thereof, a hydrolytic product thereof, an electrochemical reduction product thereof, or a combination thereof.

91. The aqueous electrolyte of claim 89, wherein the electrolyte additive is 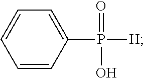
or a salt thereof, an anion thereof, a hydrolytic product thereof, an electrochemical reduction product thereof, or a combination thereof.

92. The aqueous electrolyte of claim 89, wherein the electrolyte additive is 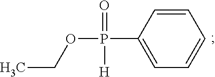
or a salt thereof, an anion thereof, a hydrolytic product thereof, an electrochemical reduction product thereof, or a combination thereof.

93. The aqueous electrolyte of claim 89, wherein the electrolyte additive is 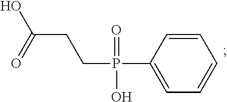 [SMILES: O=C(O)CCP(=O)(O)c1ccccc1]
or a salt thereof, an anion thereof, a hydrolytic product thereof, an electrochemical reduction product thereof, or a combination thereof.

94. The aqueous electrolyte of claim 79, wherein the electrolyte additive or combination of electrolyte additives is present in the aqueous electrolyte at a concentration equal to, or greater than, about 0.001 wt % to less than, or equal to, 1 wt %.

95. The aqueous electrolyte of claim 79, wherein the electrolyte additive or combination of electrolyte additives is present in the aqueous electrolyte at a concentration equal to, or greater than, about 0.001 wt % to less than, or equal to, 0.5 wt %.

96. The aqueous electrolyte of claim 79, wherein the electrolyte additive or combination of electrolyte additives is present in the aqueous electrolyte at a concentration equal to, or greater than, about 0.01 wt % to less than, or equal to, 0.5 wt %.

97. The aqueous electrolyte of claim 79, wherein the electrolyte additive or combination of electrolyte additives is present in the aqueous electrolyte at a concentration equal to, or greater than, about 0.1 wt % to less than, or equal to, 0.5 wt %.

98. An electrochemical cell comprising an anode wherein the anode is zinc; a cathode selected from the group consisting of oxygen, lithium, carbon, cerium, chloride, bromide, iodide, iron, manganese dioxide, nickel, and silver oxide; and an aqueous electrolyte of claim 79.
